(19) United States
(12) Patent Application Publication
(10) Pub. No.: US 2025/0117369 A1
(43) Pub. Date: Apr. 10, 2025

(54) METHODS AND SYSTEMS THAT AUTOMATICALLY GENERATE SCHEMA FOR CLOUD-INFRASTRUCTURE-SPECIFICATION-AND-CONFIGURATION FILES THAT ARE USED FOR AUTOCOMPLETION AND VALIDATION

(71) Applicant: VMware LLC, Palo Alto, CA (US)

(72) Inventors: Priyank Agarwal, Bangalore (IN); Praveen Kumar, Bangalore (IN)

(21) Appl. No.: 18/649,861

(22) Filed: Apr. 29, 2024

(30) Foreign Application Priority Data
Oct. 10, 2023 (IN) 202341067724

(51) Int. Cl. G06F 16/21

(52) U.S. Cl. CPC G06F 16/212

(57) ABSTRACT

The current document is directed to an IaC cloud-infrastructure-management service or system that automatically generates schema for cloud-infrastructure-specification-and-configuration files used by integrated development environments (“IDEs”), associated with the IaC cloud-infrastructure-management service or system, for autocompletion and validation. The IaC cloud-infrastructure management service or system accesses cloud-provider plug-ins to collect information and then encodes collected information regarding resource types, resource-type-associated functions and function arguments, cloud-infrastructure-specification-and-configuration data-file syntax, and other relevant information into cloud-infrastructure-specification-and-configuration data-file schemas. The schemas are input to integrated IDEs to control autocompletion and cloud-infrastructure-specification-and-configuration data-file validation.

### RELATED APPLICATIONS

This application claims priority to Indian application Ser. No. 202341067724 filed Oct. 10, 2023, by VMware LLC, entitled “METHODS AND SYSTEMS THAT AUTOMATICALLY GENERATE SCHEMA FOR CLOUD-INFRASTRUCTURE-SPECIFICATION-AND-CONFIGURATION FILES THAT ARE USED FOR AUTOCOMPLETION AND VALIDATION,” which is hereby incorporated by reference in its entirety for all purposes.

### TECHNICAL FIELD

The current document is directed to distributed-computer-systems and, in particular, to an infrastructure-as-code (“IaC”) cloud-infrastructure-management service or system that automatically generates schema, for cloud-infrastructure-specification-and-configuration files, that are used for autocompletion and validation.

### BACKGROUND

During the past seven decades, electronic computing has evolved from primitive, vacuum-tube-based computer systems, initially developed during the 1940s, to modern electronic computing systems, including distributed cloud-computing systems, in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including distributed service-oriented applications. Distributed applications, including distributed service-oriented applications and distributed microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated and semi-automated management and administration subsystems impractical, from a time and cost standpoint. Therefore, designers and developers of distributed computer systems and applications continue to seek new approaches to implementing automated and semi-automated management-and-administration facilities and functionalities.

### SUMMARY

The current document is directed to an IaC cloud-infrastructure-management service or system that automatically generates schema for cloud-infrastructure-specification-and-configuration files used by integrated development environments (“IDEs”), associated with the IaC cloud-infrastructure-management service or system, for autocompletion and validation. The IaC cloud-infrastructure management service or system accesses cloud-provider plug-ins to collect information and then encodes collected information regarding resource types, resource-type-associated functions and function arguments, cloud-infrastructure-specification-and-configuration data-file syntax, and other relevant information into cloud-infrastructure-specification-and-configuration data-file schemas. The schemas are input to integrated IDEs to control autocompletion and cloud-infrastructure-specification-and-configuration data-file validation.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates a number of different cloud-computing facilities that provide computational infrastructure to an organization for supporting the organization's distributed applications and services.

FIG. 9 illustrates a universal-management-interface provided by the currently disclosed IaC cloud-infrastructure-management service.

FIG. 10 illustrates a portion of the architecture of the IaC cloud-infrastructure-management service.

FIG. 11 illustrates the cloud-management interface provided by the IaC cloud-infrastructure-management service.

FIG. 12 illustrates components of a GraphQL API interface.

FIGS. 13A-14E illustrate an example schema, an extension to that example schema, and queries, a mutation, and a subscription to illustrate the GraphQL data query language.

FIG. 15 illustrates a stitching process.

FIGS. 16A-D illustrate the YAML Ain't Markup Language (“YAML”) data serialization language.

FIG. 17 illustrates certain features provided by the Jinja template engine that are used, in addition to YAML, for representing infrastructure in SLS documents.

FIGS. 18A-C illustrate a structured labor state (“SLS”) data file and credential file as well as the output from an Idem describe command.

FIG. 19 illustrates a fundamental control loop involving the Idem service.

FIG. 20 illustrates one implementation of the Idem service.

FIGS. 21A-B illustrate autocompletion and validation of a cloud-infrastructure-specification-and-configuration data file during creation of the cloud-infrastructure-specification-and-configuration data file by a user using an IDE.

FIGS. 22A-B provide control-flow diagrams that illustrate an example implementation of automated cloud-infrastructure-specification-and-configuration-data-file schema generation.

FIGS. 23A-B illustrate a schema automatically generated by the currently disclosed methods and systems.

FIGS. 24A-B show a small, example schema.

FIG. 25 illustrates use of a schema by an IDE.

### DETAILED DESCRIPTION

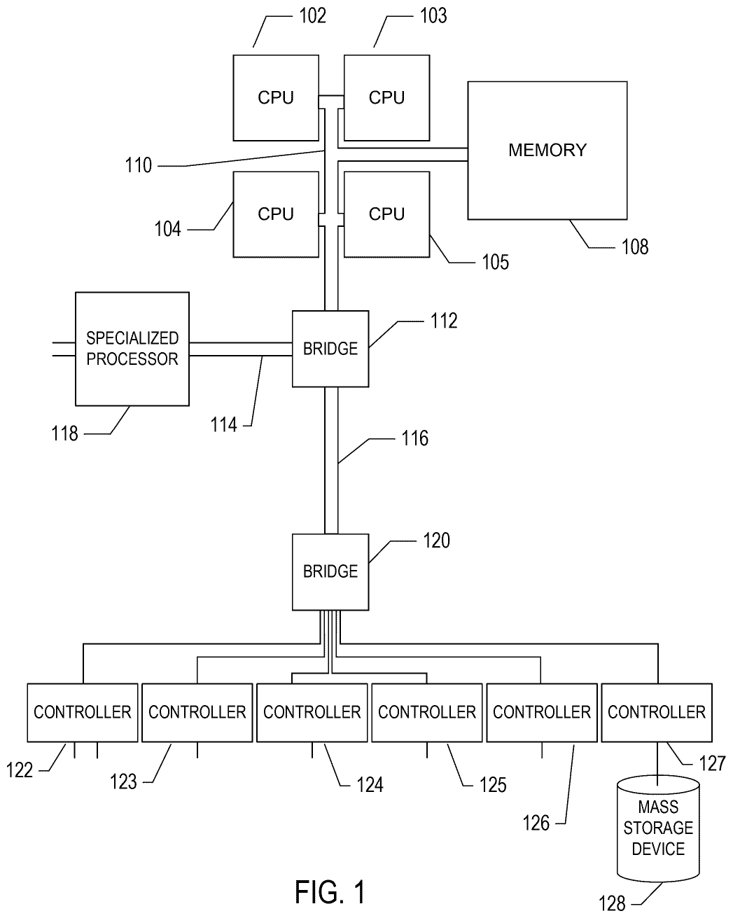

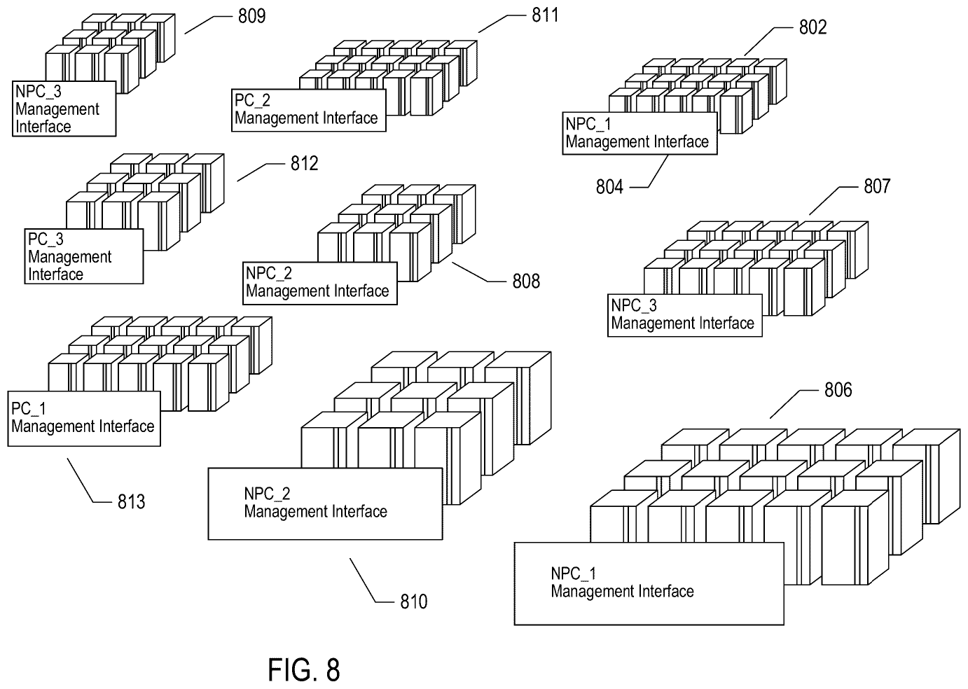

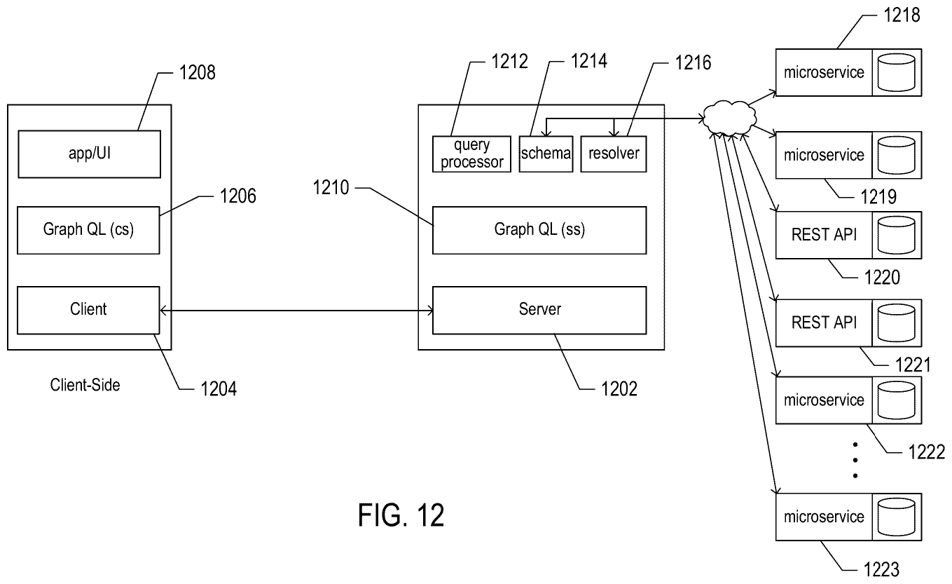

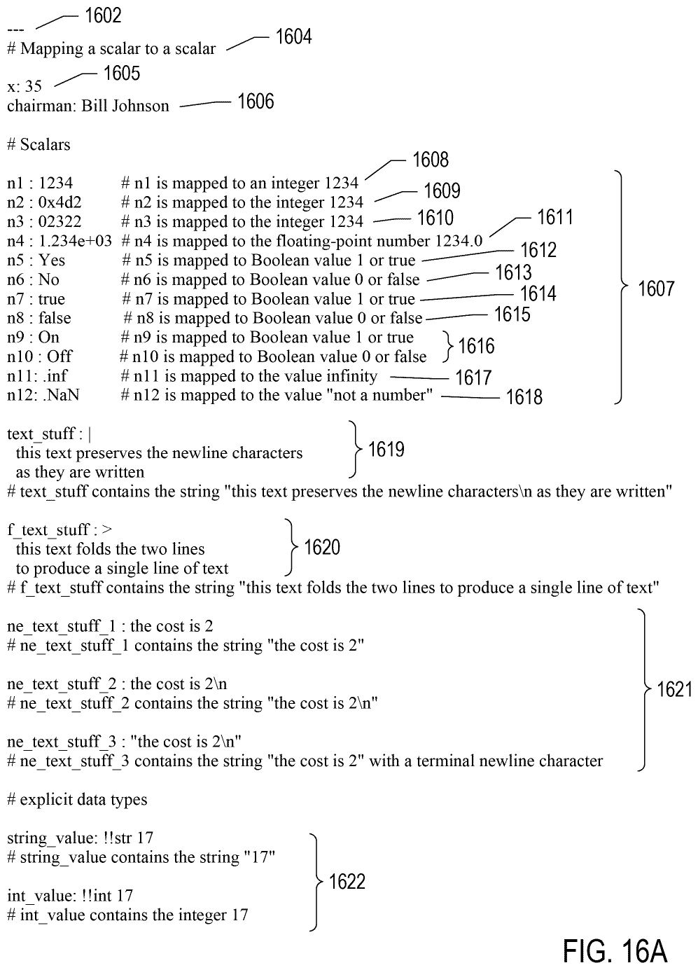

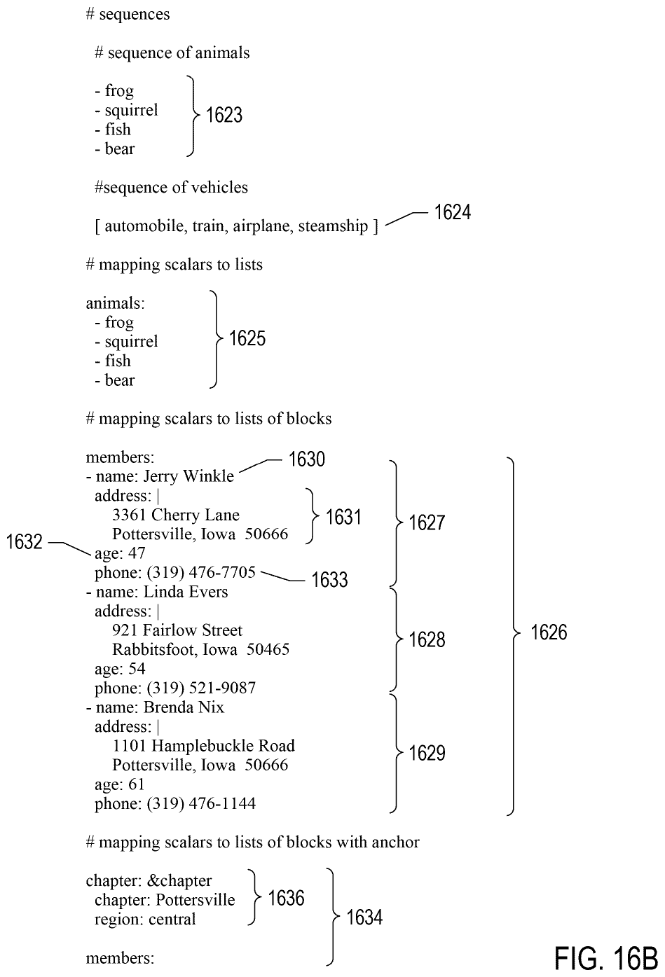

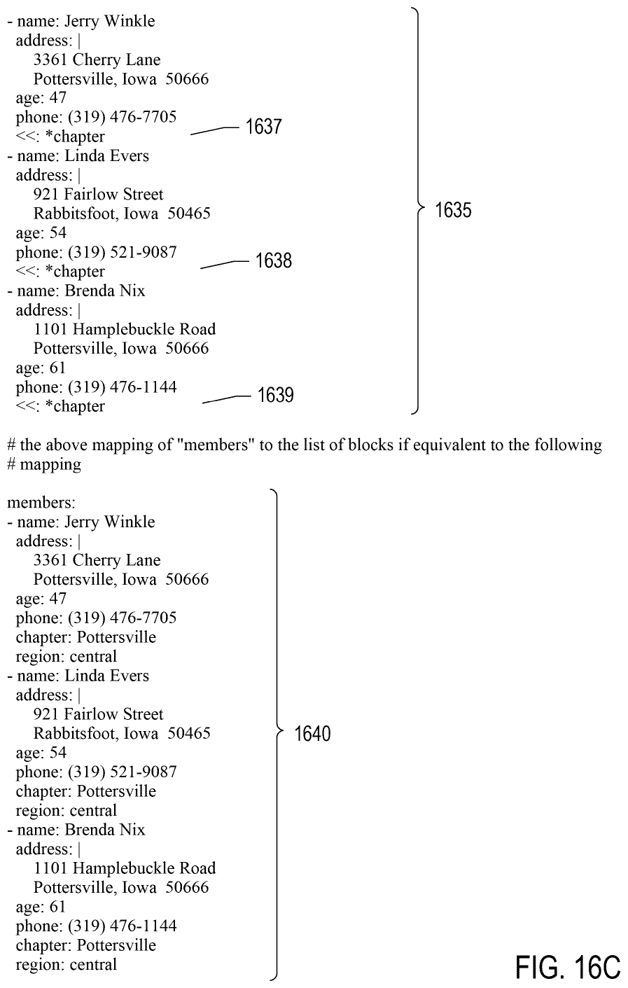

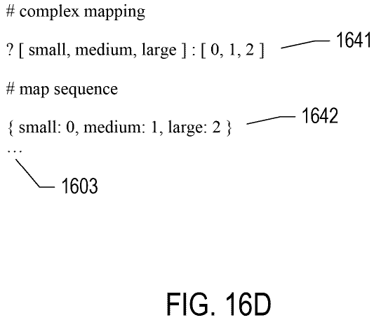

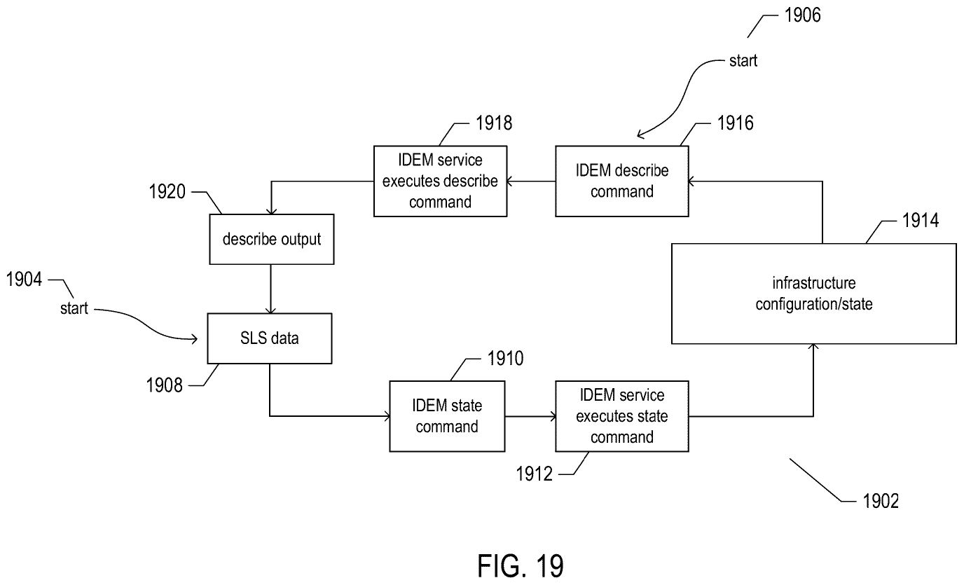

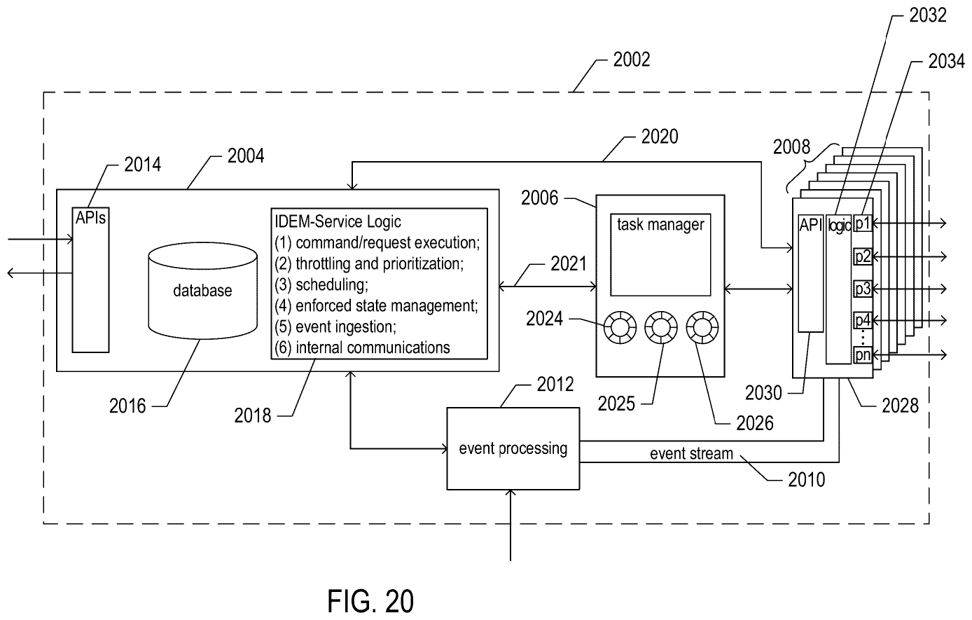

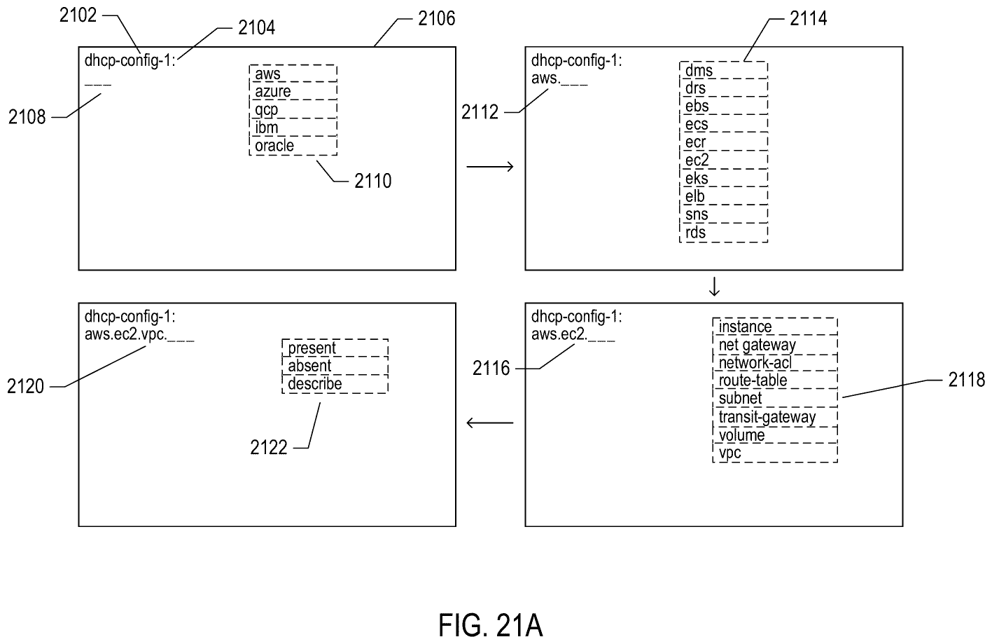

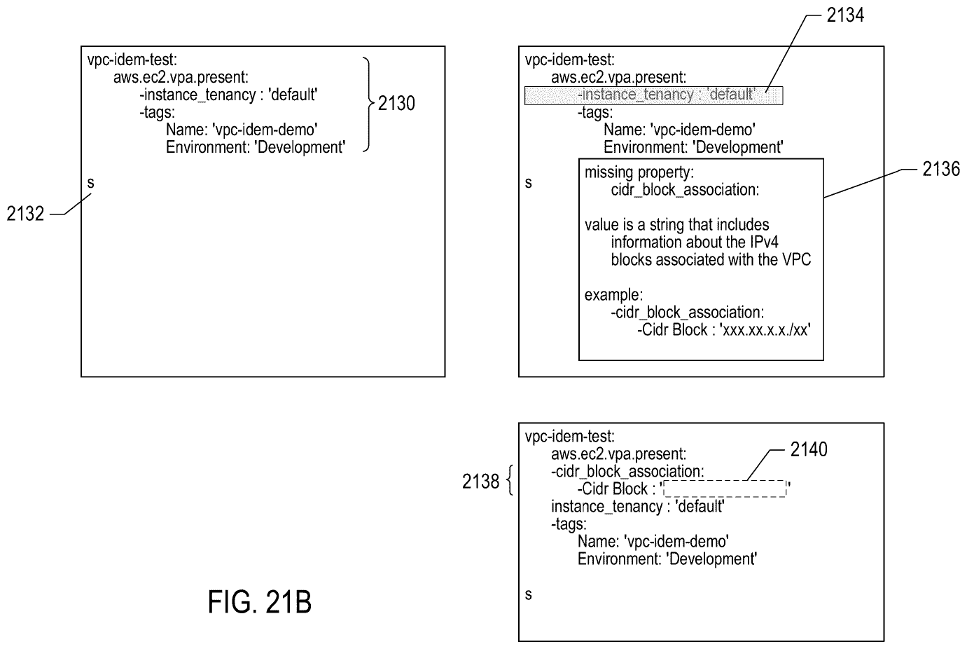

The current application is directed to an IaC cloud-infrastructure-management service or system that automatically generates schema, for cloud-infrastructure-specification-and-configuration files, that are used by the IaC cloud-infrastructure-management service for system for autocompletion and validation. In a first subsection, below, a detailed description of computer hardware, complex computational systems, and virtualization is provided with reference to FIGS. 1-7. In a second subsection, an overview of an IaC cloud-infrastructure-management service is provided, with reference to FIGS. 8-11. A third subsection provides an overview of the GraphQL API interface with reference to FIGS. 12-15. A fourth subsection provides an overview of YAML, JINJA, and SLS documents with reference to FIGS. 16-18C. A fifth subsection provides an overview of the Idem service reference to FIGS. 19-20. Finally, in a sixth subsection, the currently disclosed methods and systems are discussed with reference to FIGS. 21-25.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

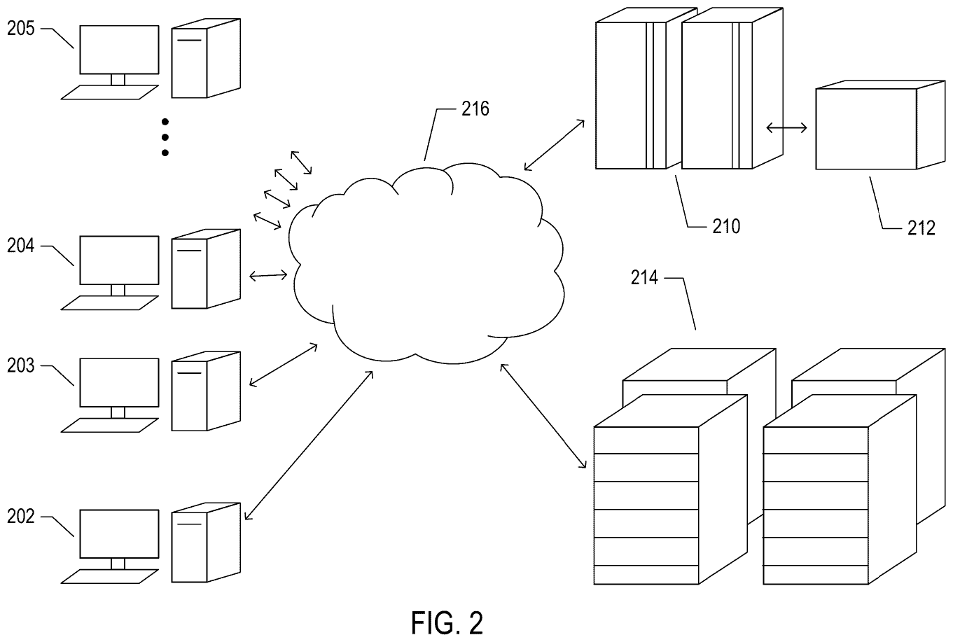

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

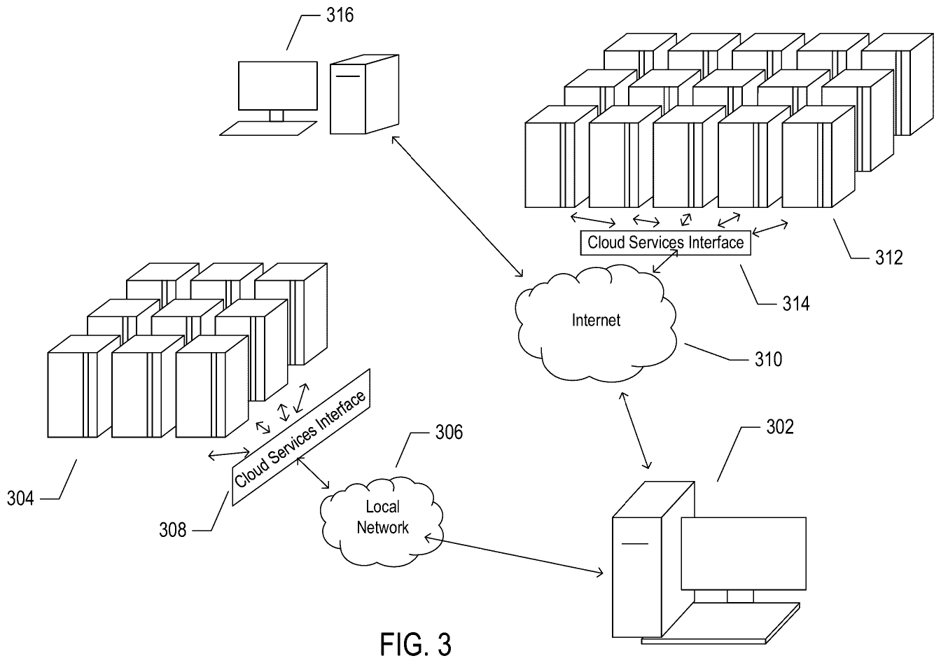

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

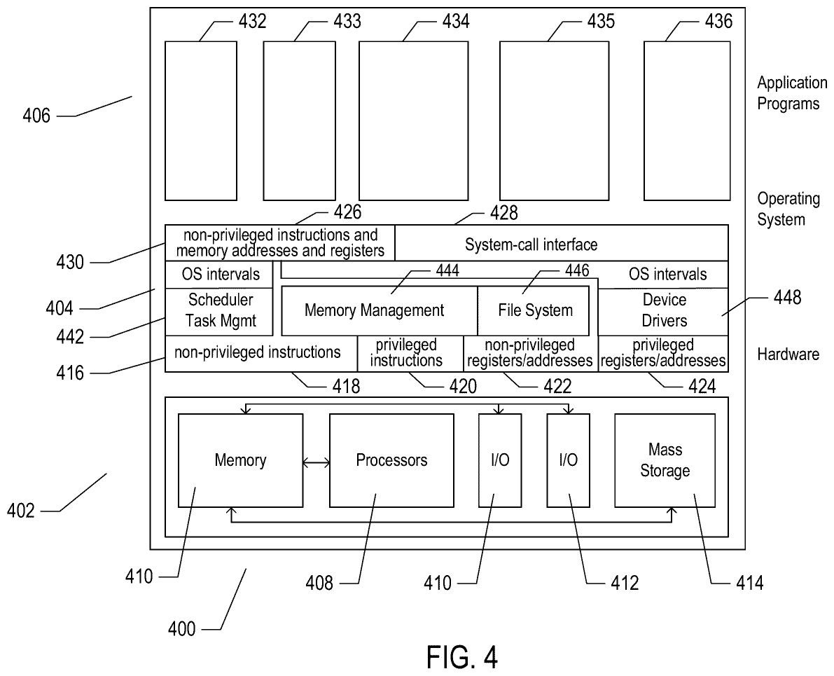

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

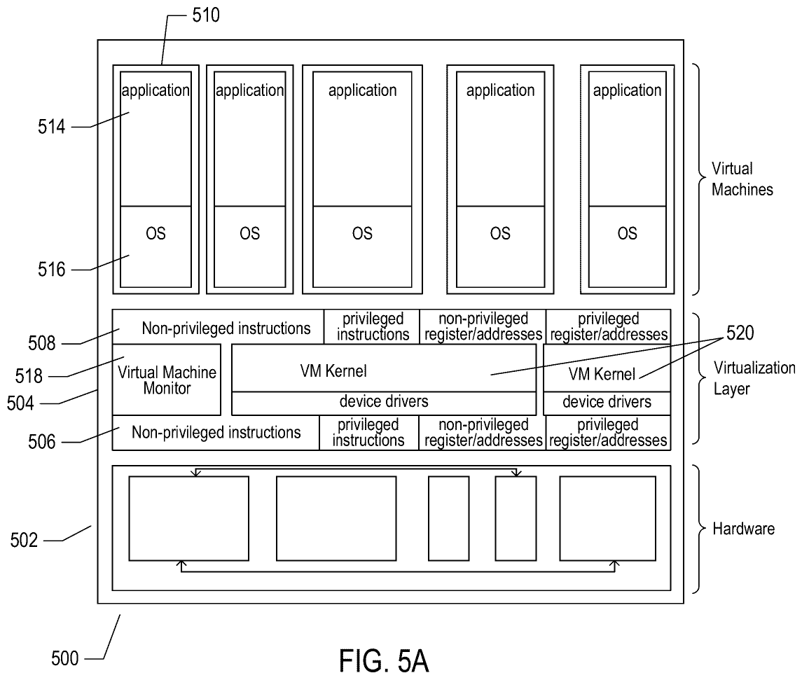

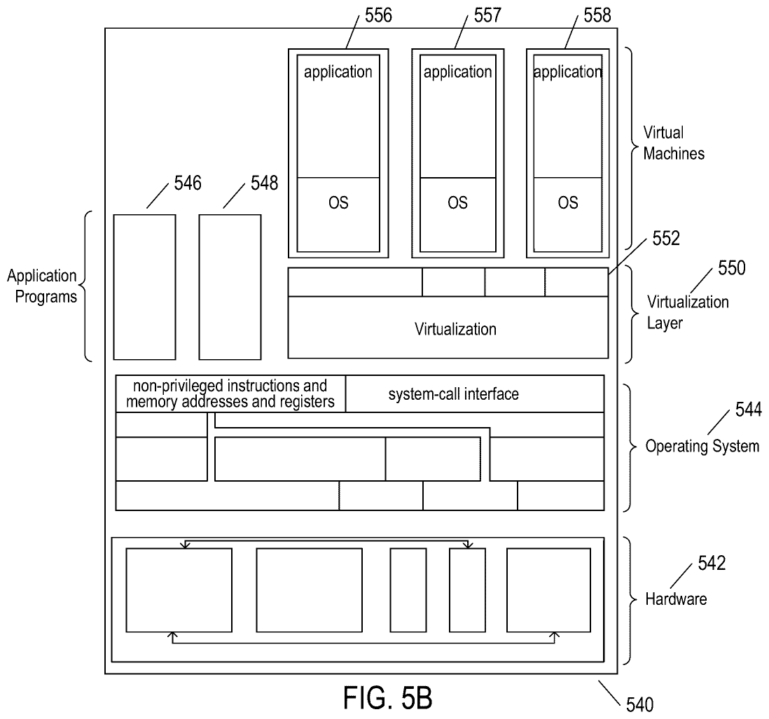

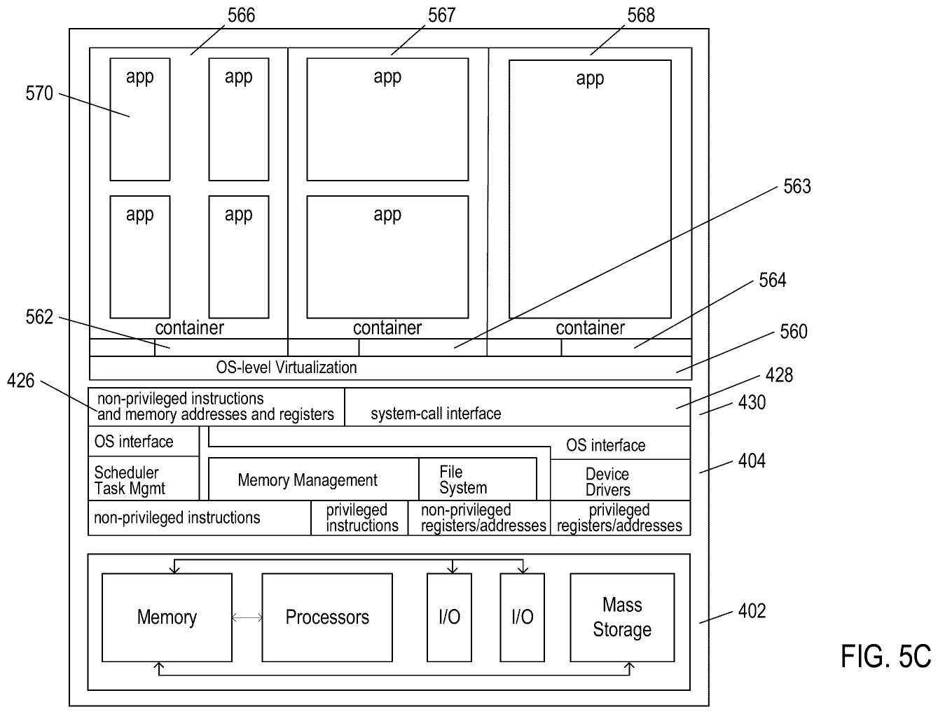

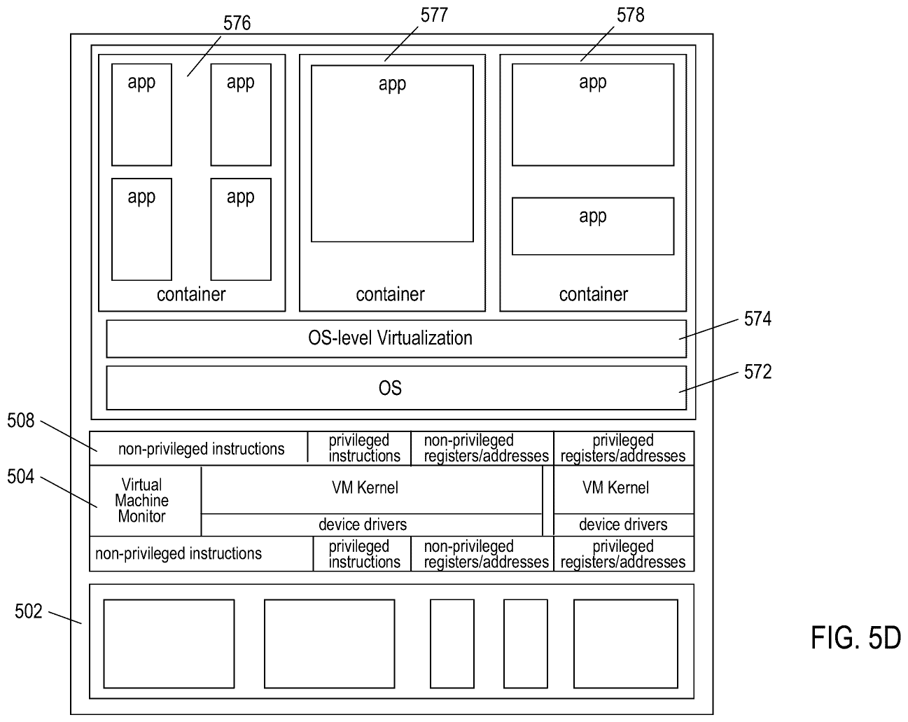

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

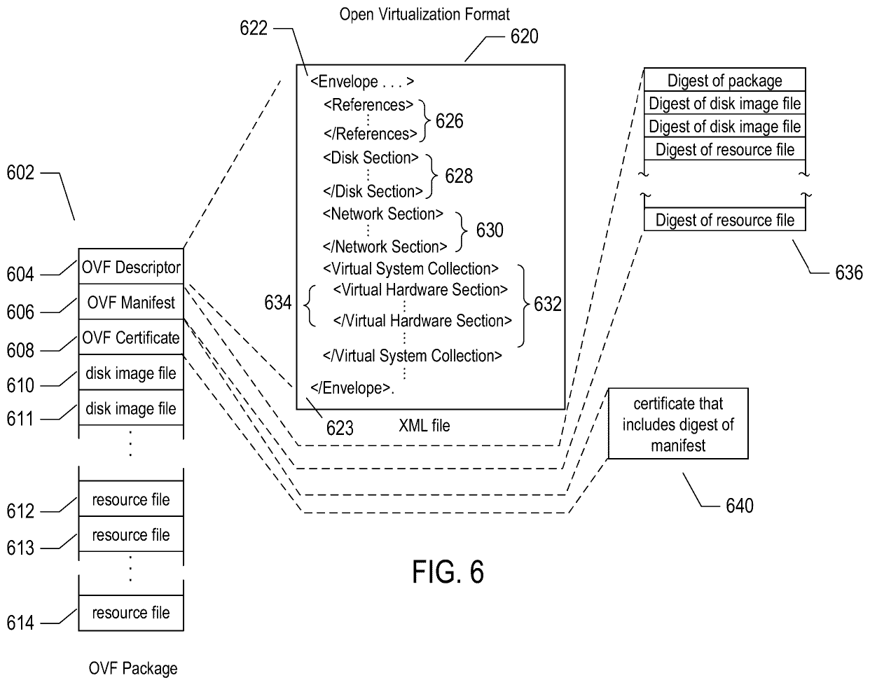

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

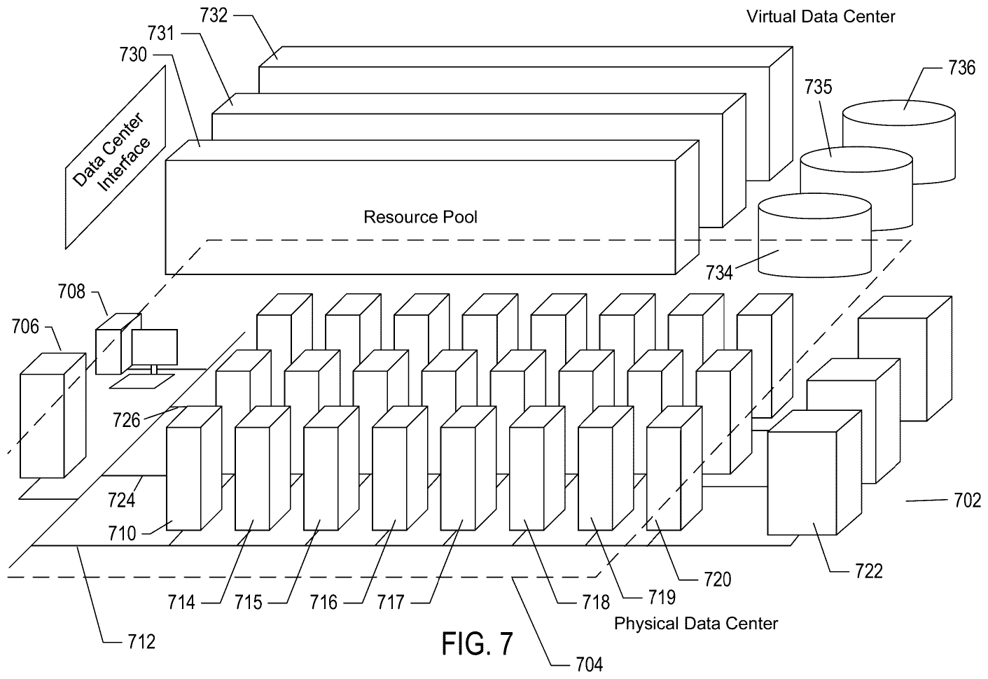

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### Overview of an IaC Cloud-Infrastructure-Management Service

FIG. 8 illustrates a number of different cloud-computing facilities that provide computational infrastructure to an organization for supporting the organization's distributed applications and services. The cloud-computing facilities are each represented by an array of cabinets containing servers, data-storage appliances, communications hardware, and other computational resources, such as the array of cabinets 802. Each cloud-computing facility provides a management interface, such as management interface 804 associated with cloud-computing facility 802. The organization leases computational resources from a number of native-public-cloud cloud-computing facilities 802 and 806-810 and also obtains computational resources from multiple private-cloud cloud-computing facilities 811-813. The organization may wish to move distributed-application and distributed-service instances among the cloud-computing facilities to take advantage of favorable leasing rates, lower communications latencies, and desirable features and policies provided by particular cloud-computing facilities. In addition, the organization may wish to scale-up or scale-down the computational resources leased from different cloud-computing facilities in order to efficiently handle dynamic workloads. All of these types of operations involve issuing commands and requests through the management interfaces associated with the cloud-computing facilities. In the example shown in FIG. 8, cloud-computing facilities 802 and 806 are accessed through a first type of management interface, cloud-computing facilities 808 in 810 are accessed through a second type of management interface, and cloud-computing facilities 807 and 809 are accessed through a third type of management interface. The management interfaces associated with private-cloud cloud-computing facilities 811-813 are different from one another and from the native-public-cloud management interfaces.

The many different management interfaces represent a challenge to management and administration personnel within the organization. The management personnel need to be familiar with a variety of different management interfaces that may involve different command sets, different command-set syntaxes, and different features, In addition, the different management interfaces may accept different types of blueprints or cloud templates that specify the infrastructure and infrastructure configuration desired by the organization. It may be difficult for management personnel to determine whether certain desired features and functionalities easily accessed and obtained through certain types of management interfaces are even provided by cloud-computing facilities associated with other types of management interfaces. Different management interfaces may require different types of authentication and authorization credentials which further complicates management operations performed by management and administration personnel. These problems may even be of greater significance when computational resources are leased from cloud-computing facilities and configured and managed by automated management systems.

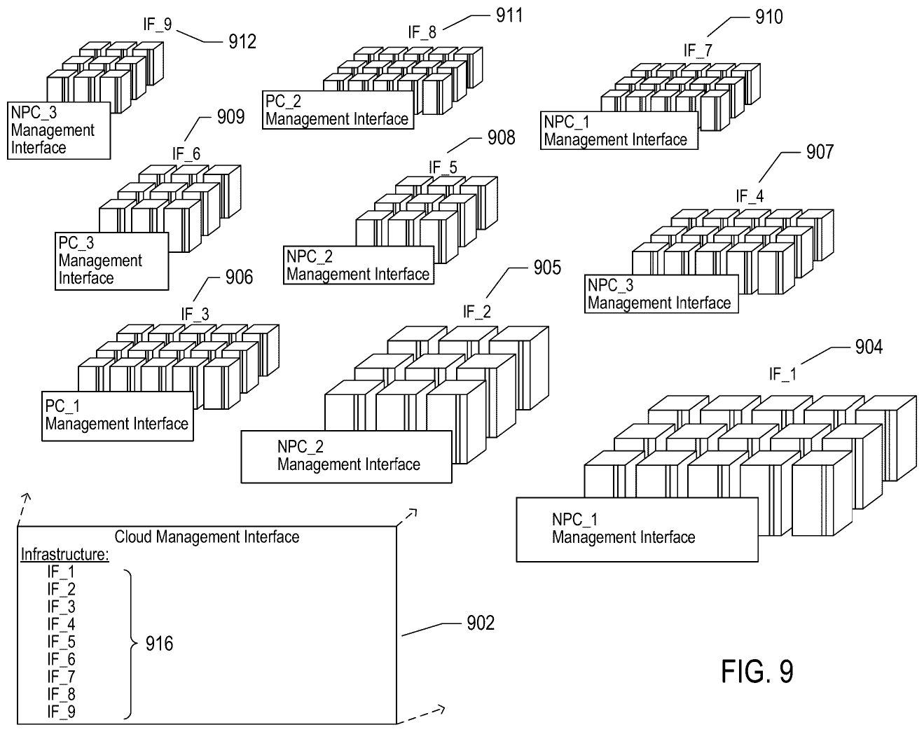

To address the problems associated with multiple different management interfaces to multiple different cloud-computing facilities, discussed in the preceding paragraph, an IaC cloud-infrastructure-management service provides a single, universal management interface through which management and administration personnel as well as automated management systems define and deploy cloud-based infrastructure within many different types of cloud-computing facilities. FIG. 9 illustrates a universal-management-interface provided by the IaC cloud-infrastructure-management service. The IaC cloud-infrastructure-management service provides a cloud-management interface 902 through which both human management personnel and automated management systems can manage computational infrastructure provided by many different types of underlying cloud-computing facilities associated with various different types of management interfaces. The infrastructure deployed and configured within the various cloud-computing facilities is represented in FIG. 9 by the labels “IF_1” 904, “IF_2” 905, “IF_3” 906, “IF_4” 907, “IF_5” 908, “IF_6” 909, “IF_7” 910, “IF_8” 9011, and “IF_9” 912. The IaC cloud-infrastructure-management service maintains the required authentication and authorization credentials for the different underlying cloud-computing facilities on behalf of human management personnel and automated management systems and automatically provides the required authentication and authorization credentials when accessing management interfaces provided by the different underlying cloud-computing facilities. One or more common types of cloud templates or blueprints are used to specify desired infrastructure and desired infrastructure configuration within the underlying cloud-computing facilities. Each different set of computational resources that together constitute an infrastructure within each of the cloud-computing facilities is visible, and can be managed, through the cloud-management interface 902, as indicated by the infrastructure labels 916 shown within the cloud-management interface.

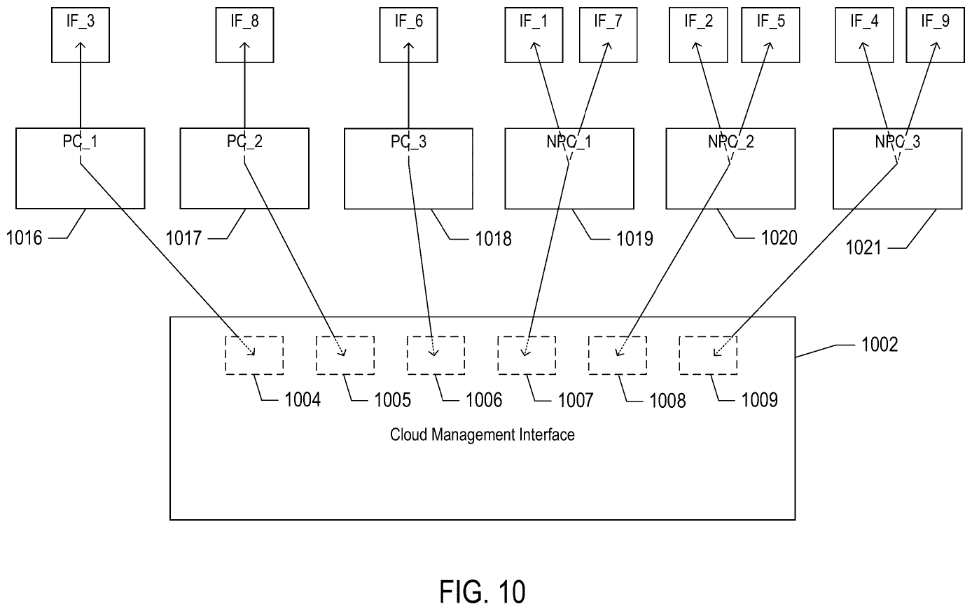

FIG. 10 illustrates a portion of the architecture of the IaC cloud-infrastructure-management service. The IaC cloud-infrastructure-management service provides a cloud-management interface 1002 that includes a common or universal set of commands that can be used to deploy and configure infrastructure in many different types of private-cloud and native-public-cloud cloud-computing facilities that provide various types of cloud-management interfaces, allowing management and administration personnel and upstream automated infrastructure-management systems to deploy and configure infrastructure across the many different types of cloud-computing facilities through a common cloud-management interface 1002. The cloud-management interface 1002 is implemented by the IaC cloud-infrastructure-management service, discussed below. The IaC cloud-infrastructure-management service includes cloud-computing-facility-specific plug-ins, represented by dashed-line rectangles 1004-1009, that implement, together with control logic within the IaC cloud-infrastructure-management service, translation of the commands and features of the cloud-management interface 1002 to the commands and features of the underlying cloud-facility-specific management interfaces 1016-1021.

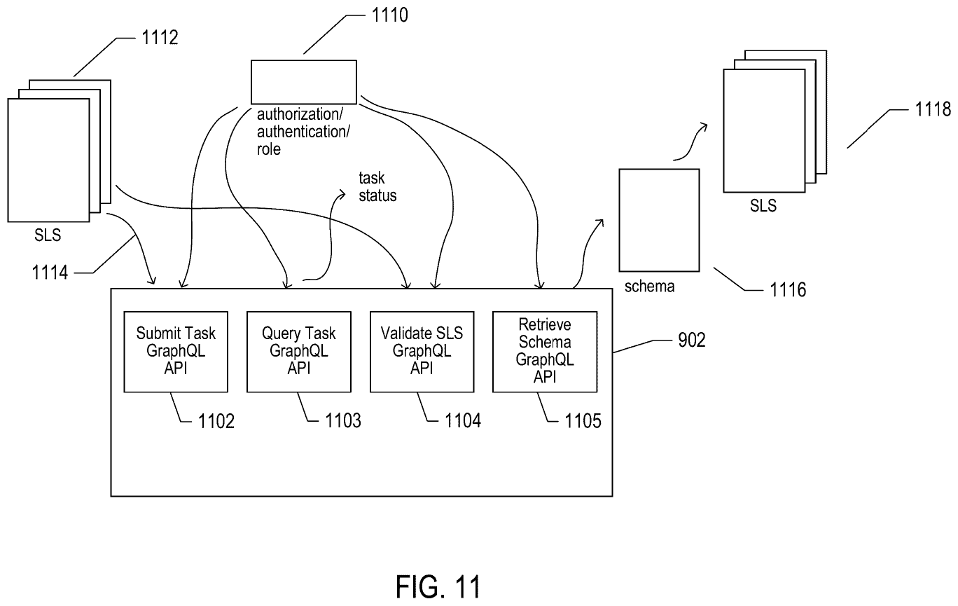

FIG. 11 illustrates the cloud-management interface provided by the IaC cloud-infrastructure-management service. The cloud-management interface 902 includes four different GraphQL application programming interfaces (“APIs”): (1) Submit Task 1102, through which deployment-and-configuration commands are input to the IaC cloud-infrastructure-management service; (2) Query Task 1103, through which status queries for previously submitted deployment-and-configuration commands and requests are input to the IaC cloud-infrastructure-management service; (3) Validate SLS 1104, through which requests to validate SLS data are input to the IaC cloud-infrastructure-management service; and (4) Retrieved Schema 1105, through which the schemas for infrastructures within underlying computing-facilities can be requested from the IaC cloud-infrastructure-management service. Requests and commands input to the IaC cloud-infrastructure-management service are generally accompanied with an authorization/authentication/role certificate or token 1110, deployment-and-configuration tasks submitted to the Submit Task API are generally accompanied with SLS data 1112 (described below), and requests for validation of SLS data are accompanied with the SLS data to be validated, as indicated by curved arrows, such as curved arrow 1114, in FIG. 11. The schema 1116 returned when a command input to the Retrieve Schema API is executed is convertible into an SLS-data specification 1118 which can be input to the Submit Task API and/or modified and input to the Submit Task API.

There are, however, many different types of IaC cloud-infrastructure-management service or system implementations. For example, an IaC cloud-infrastructure-management service or system may be alternatively implemented as a collection of plug-ins that together comprise a cloud-infrastructure-management engine and a command-line interface (“CLI”). It is, for this reason, that the current document uses the phrase “service or system” to indicate that the IaC cloud-infrastructure-management service is but one implementation approach to implementing cloud-infrastructure-management. To avoid repeating this phrase, the phrase “cloud-infrastructure manager” is used to refer to the various possible implementations of IaC cloud-infrastructure-management services or systems.

### GraphQL Interface

FIG. 12 illustrates components of a GraphQL interface. The GraphQL interface is used as an API interface by various types of services and distributed applications. For example, as shown in FIG. 12, a server 1202 provides a service that communicates with a service client 1204 through a GraphQL API provided by the server. The service client 1204 can be viewed as a computational process that uses client-side GraphQL functionality 1206 to allow an application or user interface 1208 to access services and information provided by the server 1202. The server uses server-side GraphQL functionality 1210, components of which include a query processor 1212, a storage schema 1214, and a resolver component 1216 that accesses various different microservices 1218-1223 to execute the GraphQL-encoded service requests made by the client to the server. Of course, a GraphQL API may be provided by multiple server processes in a distributed application and may be accessed by many different clients of the services provided by the distributed application. GraphQL provides numerous advantages with respect to the Representational State Transfer (“REST”) interface technology, including increased specificity and precision with which clients can request information from servers and a potential for increased data-transfer efficiencies.

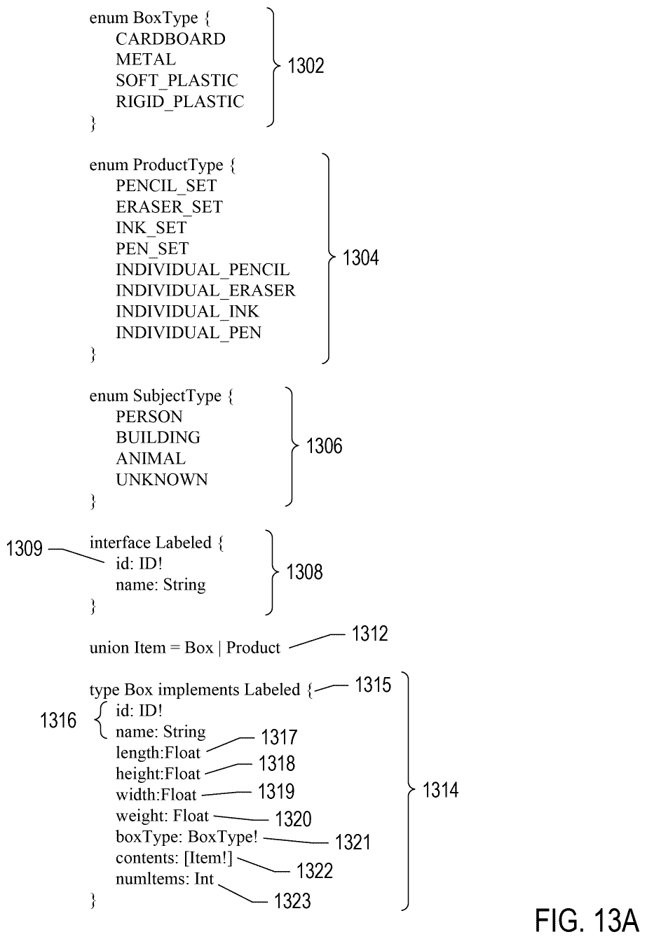

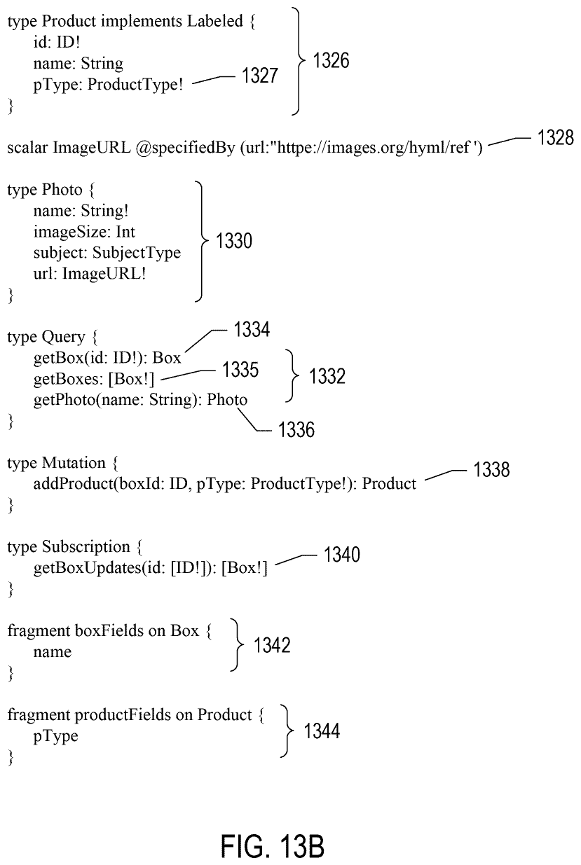

FIGS. 13A-B illustrate an example schema, an extension to that example schema, and queries, a mutation, and a subscription to illustrate the GraphQL query language. The example shown in FIGS. 13A-B does not illustrate all of the different GraphQL features and constructs, but a comprehensive specification for the GraphQL query language is provided by the GraphQL Foundation. A GraphQL schema can be thought of as the specification for an API for a service, distributed application, or other server-side entity. The example schema provided in FIGS. 13A-B is a portion of a very simple interface to a service that provides information about shipments of drafting products from a drafting-product retailer.

Three initial enumeration datatypes are specified in a first portion of FIG. 13A. The enumeration BoxType 1302 specifies an enumeration datatype with four possible values: “CARDBOARD,” “METAL,” “SOFT_PLASTIC,” and “RIGID_PLASTIC.” In the example schema, a box represents a shipment and the box type indicates the type of container in which the shipment is packaged. The enumeration ProductType 1304 specifies an enumeration datatype with eight possible values: “PENCIL_SET,” “ERASER_SET,” “INK_SET,” “PEN_SET,” “INDIVIDUAL_PENCIL,” “INDIVIDUAL_ERASER,” and “INDIVIDUAL_INK,” “INDIVIDUAL_PEN.” In the example schema, a shipment, or box, can contain products including sets of pencils, erasers, ink, and pens as well as individual pencils, erasers, ink, and pens. In addition, as discussed later, a shipment, or box, can also contain one or more boxes, or sub-shipments. The enumeration SubjectType 1306 specifies an enumeration datatype with four possible values: “PERSON,” “BUILDING,” “ANIMAL,” and “UNKNOWN.” In the example schema, the subject of a photograph is represented by one of the values of the enumeration SubjectType.

The interface datatype Labeled 1308 is next specified in the example schema. An interface datatype specifies a number of fields that are necessarily included in any object datatype that implements the interface. An example of such an object datatype is discussed below. The two fields required to be included in any object datatype that implements the interface Labeled include: (1) the field id 1309, of fundamental datatype ID; and (2) the field name 1310, of fundamental datatype String. The symbol “!” following the type specifier “ID” is a wrapping type that requires the field id to have a non-null value. The fundamental scalar datatypes in GraphQL include: (1) integers, Int; (2) floating-point values, Float; (3) Boolean values, Boolean; (4) string values, String; and (5) identifiers, ID. All of the more complex datatypes in GraphQL must ultimately comprise scalar datatypes, which can be thought of as the leaf nodes of a parse tree generated from parsing GraphQL queries, mutations, and subscriptions, discussed below. Wrapping datatypes include the non-null wrapping datatype discussed above and the list wrapping datatype indicated by bracketing a datatype, such as “[Int],” which specifies a list, or single-dimensional array, of integers or “[[Int]],” which specifies a list of lists or a two-dimensional matrix of integers.

The union Item 1312 is next specified in the example schema. A union datatype indicates that a field in an output data object can have one of the multiple datatypes indicated by the union specification. In this case, the datatype Item can be either a Box data object or a Product data object.

The Box object datatype 1314 is next specified in the example schema. An object datatype is a collection of fields that can have scalar-data-type values, wrapping-data-type values, or object data-type values. Because an object datatype may include one or more fields with object data-type values, object datatypes can describe hierarchical aggregations of data. The language “implements Labeled” 1315 indicates that the Box object datatype necessarily includes the interface Labeled fields id and name, discussed above, and those fields occur as the first two fields 1316 of the Box object datatype. The fields id and name represent a unique identifier and a name for the shipment represented by an instance of the Box object datatype. The additional fields in the Box object datatype include: (1) length 1317, of type Float, representing the length of the shipment container; (2) height 1318, of type Float, representing the height of the shipment container; (3) width 1319, of type Float, representing the width of the shipment container; (4) weight 1320, of type Float, representing the weight of the shipment container; (5) boxType 1321, of non-null enumeration type boxType, representing the type of shipment container; (6) contents 1322, an array of non-null Item data objects, representing the contents of the shipment; and (7) numItems 1323, of type Int, representing the number of items in the array contents. Since the field contents is an array of Item data objects, a box, or shipment, can contain one or more additional boxes, or sub-shipments. This illustrates how the GraphQL query language supports arbitrarily hierarchically nested data aggregations.

Turning to FIG. 13B, the example schema next specifies a Product 1326 object datatype that, like the Box object datatype, implements the interface Labeled and that additionally includes a field pType 1327 of enumeration type ProductType. An instance of the Product object datatype represents one of the different types of products that can be included in the shipment.

The example schema next specifies a custom scalar datatype ImageURL 1328 to store a Uniform Resource Locator (“URL”) for an image. The language “@specifiedBy( )” is a directive that takes a URL argument that references a description of how a String serialization of the custom scalar datatype ImageURL needs to be composed and formatted in order to represent a URL for an image. GraphQL supports a number of built-in directives and allows for specification of custom directives. Directives are essentially specifications of run-time execution details that are carried out by a server-side query processor that processes GraphQL queries, mutations, and subscriptions, discussed below. As another example, built-in directives can control query-execution to omit or include certain fields in returned data objects based on variables evaluated at the query-execution time. It should also be noted that fields in object datatypes may also take arguments, since fields are actually functions that return the specified datatypes. Arguments supplied to fields, like arguments supplied to directives, are evaluated and used at query-execution time by query processors.

The example schema next specifies the Photo object datatype 1330, which represents a photograph or image that can be accessed through the service API specified by the schema. The Photo object datatype includes fields that represent the name of the photo, and image size, the type of subject of the photo or image, and in image URL.

The example schema next specifies three queries, a mutation, and a subscription for the root Query, Mutation, and Subscription operations. A query, like a database query, requests the server-side GraphQL entity to return information specified by the query. Thus, a query is essentially an information request, similar to a GET operation on a REST API. A mutation is a request to alter stored information and is thus similar to a PUT or PATCH operation on a REST API. In addition, a mutation returns requested information. A subscription is a request to open a connection or channel through which a GraphQL client receives specified information as the information becomes available to the GraphQL server that processes the subscription request. Thus, the various data objects specified in the schema provide the basis for constructing queries, mutations, and subscriptions that allow a client to request and receive information from a server. The example schema specifies three different types of queries 1332 that can be directed, by a client, to the server via the GraphQL interface: (1) getBox 1334, which receives an identifier for a Box data object as an argument and returns a Box data object in response; (2) getBoxes 1335, which returns a list or array of Box data objects in response; and (3) getPhoto 1336, which receives the name of a photo or image as an input argument and returns a Photo data object in response. These are three examples of the many different types of queries that might be implemented in the GraphQL interface. A single mutation addProduct 1338 is specified, which receives the identifier for a Box data object and a product type as arguments and, when executed by the server, adds a product of the specified product type to the box identified by the Box data-object identifier and returns a Product data object representing the product added to the box. A single subscription getBoxUpdates receives a list of Box data-object identifiers, as an argument, and returns a list of Box data objects in each response returned through the communications channel opened between the client and server for transmission of the requested information, over time, to the client. In this case, the client receives Box data objects corresponding to any of the boxes specified in the argument to the subscription getBoxUpdates when those Box data objects are updated, such as in response to addProduct mutations submitted to the server.

Finally, the example schema specifies two fragments: (1) boxFields 1342; and (2) productFields 1344. A fragment specifies one or more fields of an object datatype. Fragments can be used to simplify query construction by expanding a fragment, using the operator “ . . . ” in a selection set of a query, mutation, or subscription, as discussed below, rather than listing each field in the fragments separately in the selection set. A slightly different use of fragments is illustrated in example queries, below. In the current case, the fragment boxFields includes only the single field name of the Box data-object type and the fragment productFields includes only the single field name pType of the Product datatype.

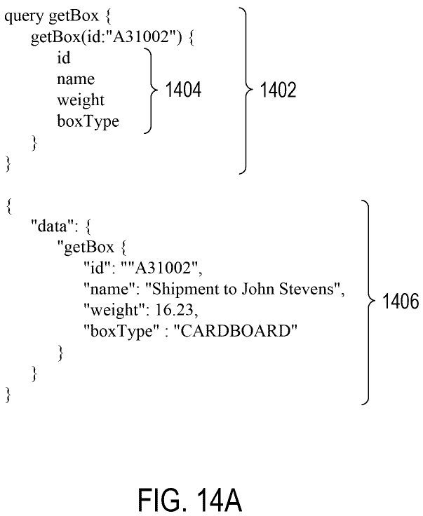

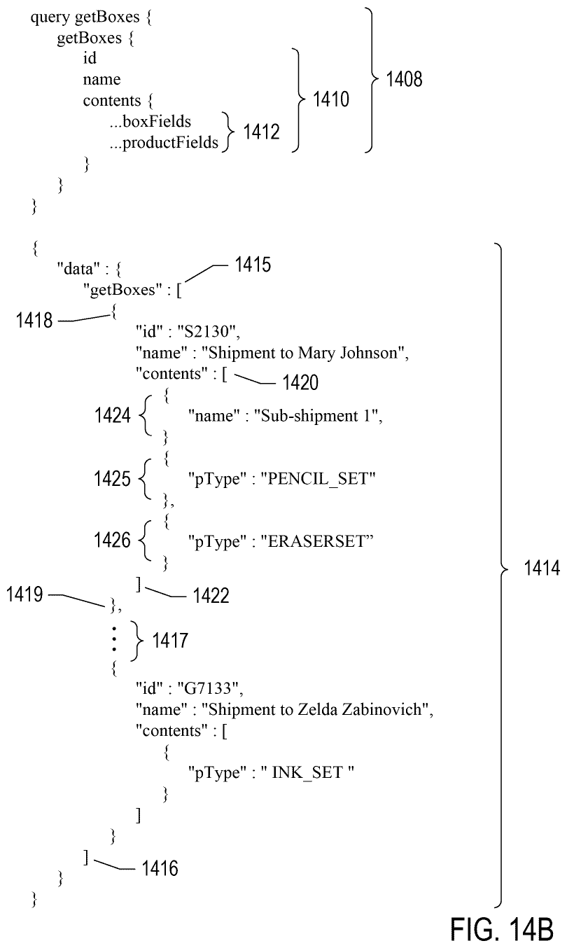

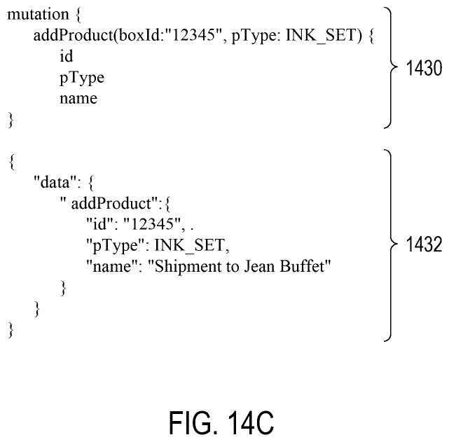

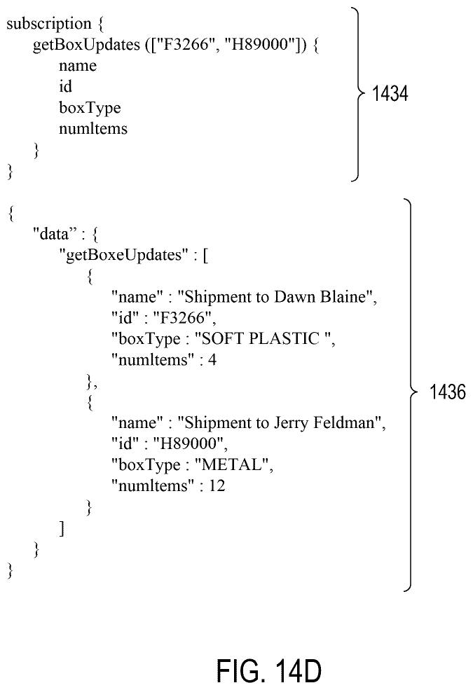

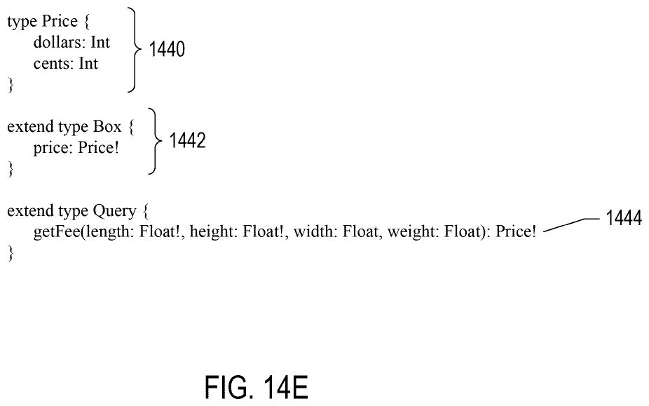

FIGS. 14A-D illustrates two example queries, an example mutation, and an example subscription based on the example schema discussed with reference to FIGS. 13A-B. FIG. 14A shows an example query 1402 submitted by a client to a server and the JavaScript Object Notation (“JSON”) data object returned by the server to the client. Various different types of data representations and formats can be returned by servers implementing GraphQL interfaces, but JSON is a commonly used data representation and formatting convention. The query 1402 is of the query type 1334 specified in FIG. 13B. The argument specified for the query is “A31002,” the String serialization of a Box identifier. A selection set 1404 for the query specifies that the client issuing the query wishes to receive only values for the id, name, weight, and boxType fields of the Box data object with identifier “A31002.” The JSON response to the query 1406 contains the requested information. This points to one of the large advantages provided by the GraphQL query language. A client can specify exactly the information the client wishes to receive from the server, rather than receiving predefined information for predefined queries provided by a REST interface. In this case, the client is not interested in receiving values for many of the fields in the Box data object and is able to use a selection set in the query to request only those fields that the client is interested in receiving.

FIG. 14B illustrates a second example query based on the example schema discussed with reference to FIGS. 13A-B. The second example query 1408 is of the query type 1335 specified in FIG. 13B. A selection set 1410 within the query requests that, for each Box data object currently maintained by the server, values for the id, name, and contents fields of the Box data object should be returned. The contents field has a list type and specifies a list of Item data objects, where an Item may be either a Box data object or a Product data object. A selection set 1412 for the contents field uses expansion of the boxFields and productFields fragments to specify that, for each Item in the list of Item data objects represented by the contents field, if the Item is a Box data object, then the value of the name field for that Box data object should be returned while, if the Item is a Product data object, then the value of the pType field of the Product data object should be returned. The JSON response 1414 to query 1408 is shown in the lower portion of FIG. 14B. The returned data is a list of the requested fields of the Box data object currently maintained by the server. That list begins with bracket 1415 and ends with bracket 1416. Ellipsis 1417 indicates that there may be additional information in the response for additional Box data objects. The requested data for the first Box data object occurs between curly brackets 1418 and 1419. The list of items for the contents of this Box data object begin with bracket 1420 and end with bracket 1422. The first Item 1424 in the list is a Box data object and the second two Item data objects 1425 and 1426 are Product data objects. The second example query illustrates that a client can receive a large amount of arbitrarily related information in one request-response interaction with a server, rather than needing to use multiple request-response interactions. In this case, a list of portions of multiple Box data objects can be obtained in one request-response interaction. As another example, in a typical REST interface, a client may need to submit a request to separately retrieve information for each Box data object contained within an outer-level Box data object, but, using a hierarchical object datatype, that information can be requested in a single GraphQL query.

FIG. 14C illustrates an example mutation based on the example schema discussed with reference to FIGS. 13A-B. The example mutation 1430 is of the mutation type 1338 specified in FIG. 13B. The mutation requests that the server add a product of type INK_SET to the Box data object identified by Box data-object identifier “12345” and return values for the id, pType, and name fields of the updated Box data object. The JSON response 1432 to query 1430 is shown in the lower portion of FIG. 14C. FIG. 14D illustrates an example subscription based on the example schema discussed with reference to FIGS. 13A-B. The example subscription 1434 is of the subscription type 1340 specified in FIG. 13B. The subscription requests that the server return, for updated Box data objects identified by Box data-object identifiers “F3266” and “H89000,” current values for the name, id, boxType, and numItems fields. One of the JSON responses 1436 to subscription 1434 returned at one point in time is shown in the lower portion of FIG. 14D.

FIG. 14E illustrates a second schema, based on the first example schema of FIGS. 13A-B and generated by extending the first example schema. The second schema may be used as an interface to a different service that returns shipment fees associated with Box data objects that represent shipments. The schema extension includes specification of a new Price data object 1440, extension of the object datatype Box to include an additional field price with a Price data-object value 1442, and extending the root Query operation type to include a getFee query 1444 that receives the length, height, width, and weight of a shipment and returns the corresponding shipment price or cost. Thus, GraphQL provides for extension of schemas to generate new extended schemas to serve as interfaces for new services, distributed applications, and other such entities.

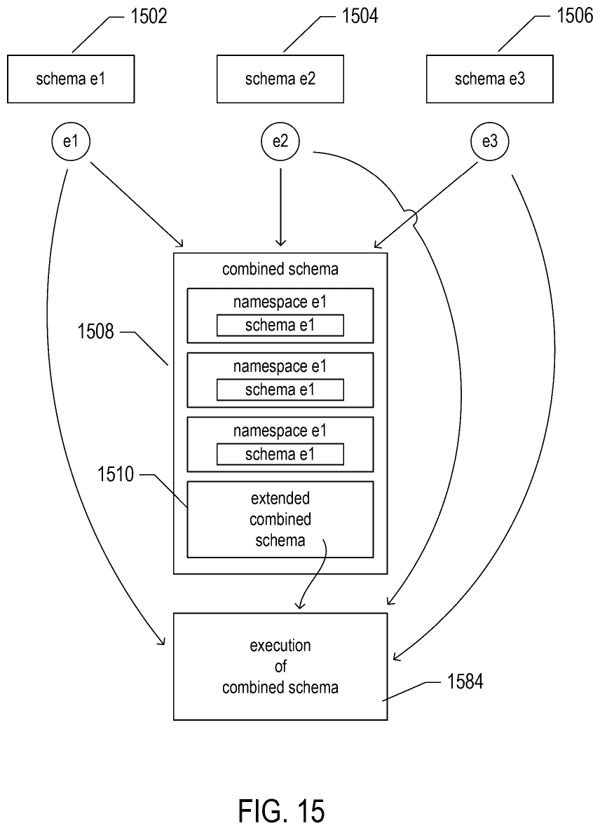

FIG. 15 illustrates a stitching process. Schema stitching is not formally defined by the GraphQL query-language specification. The GraphQL query-language specification specifies that a GraphQL interface is represented by a single schema. However, in many cases, it may be desirable to combine two or more schemas in order to produce a combined schema that is a superset of the two or more constituent schemas, allowing queries, mutations, and subscriptions based on the combined schema to employ object datatypes and other defined types and directives specified in two or more of the constituent schemas. There are multiple different types of implementations of schema stitching. In an example shown in FIG. 15, there are three underlying schemas 1502-1504. The stitching process combines these three schemas into a combined schema 1508. The combined schema includes the underlying schemas. In the illustrated approach to stitching, each underlying schema is embedded in a different namespace in the combined schema, which may include additional extensions 1510. The namespaces are employed in order to differentiate between identical identifiers used in two or more of the underlying schemas. Other approaches to stitching may simply add extensions to all or a portion of the type names defined in all of the underlying schemas in order to generate unique names across all of the underlying schemas. In the combined schema, queries, mutations, and subscriptions may use types from all of the underlying schemas and, in combined-schema extensions of underlying-schema types, a type defined in one underlying schema can be extended to reference a type defined in a different underlying schema. When a query, mutation, or subscription defined in the combined schema is executed, the execution 1514 may involve execution of multiple queries by multiple different services associated with the underlying schemas.

### YAML/JINJA and SLS Data

FIGS. 16A-D illustrate the YAML Ain't Markup Language (“YAML”) data serialization language. YAML provides for representing data in text files. Certain features of YAML are illustrated by the YAML document shown in FIGS. 16A-D. A YAML document begins with three hyphens (1602 in FIG. 16A) and ends with three periods (1603 in FIG. 16D.) Multiple YAML documents can be included in a single text file. Comments begin with a “#” symbol followed by a space, such as the comment 1604. One of the fundamental constructs in YAML is a mapping of a scalar value to a scalar string, or name, such as the mapping 1605 of the integer value 35 to the name “x” and the mapping 1606 of the string value “Bill Johnson” to the name “Chairman.” YAML supports a variety of different types of scalars, as shown in the set of mappings 1607, including: integers encoded as decimal integers 1608, integers encoded as hexadecimal integers 1609, and integers encoded as octal integers 1610; floating-point numbers 1611; Boolean values “Yes” 1612 and “No” 1613, “true” 1614 and “false” 1615, and “On” and “Off” 1616; a value representing infinity 1617; and a value representing “not a number” 1618. On lines 1619, two text lines are mapped to the name “text_stuff,” with the symbol “|” used to indicate that newline characters in the text should be preserved. On lines 1620, two text lines are mapped to the name “f_text_stuff,” with the symbol “>” indicating that newlines should be removed in order to fold the text into a single text block. Text can be unquoted or quoted, as indicated by the examples on lines 1621. The “!” operator can be used to explicitly assign types to values, as indicated on lines 1622.

Turning to FIG. 16B, another fundamental data structure supported by YAML is the sequence or list. Several different representations of lists are supported. In a first representation of a list 1623, the elements of the list are indicated by a preceding “-” and a space. In a second representation 1624, the elements of the list are contained within brackets and separated by commas and spaces. As indicated on lines 1625, a list can be mapped to a name. In the example of lines 1625, a list of animals is mapped to the character string, or name, “animals.” Note that indentation is used, as in the Python programming language, to indicate hierarchical structure.

Lines 1626 show a mapping of a more complex type of list to the name, or character string, “members.” In this example, the list is a list of blocks 1627-1629. Each block is preceded by a hyphen and a space. Each block contains a mapping of a character string to the character string “name” 1630, a mapping of two text lines to the character string “address” 1631, a mapping of an integer to the character string “age” 1632, and a mapping of an alphanumerically encoded phone number to the character string “phone” 1633. In the example of lines 1634 at the bottom of FIG. 16B and lines 1635 at the top of FIG. 16C, the mapping of the list of blocks to the character string “members” on lines 1626 of FIG. 16B is modified to include two additional lines in each block of the list. The two additional lines are specified using the anchor symbol “&” on lines 1636 at the bottom of FIG. 16B. The lines are included at the end of each block in the list using the reference prefix “<<: *” at the beginning of each of three lines referencing the anchor “chapter” 1637-1639. The modified list is equivalent to the list shown on lines 1640 of FIG. 16C. Finally, on line 1641 at the top of FIG. 16D, a more complex mapping that maps the list “[0, 1, 2]” to the list “[small, medium, large]” is shown. This mapping can alternatively be represented by the map sequence, or dictionary, shown on line 1642. The example YAML document shown in FIG. 16A-D does not, of course, provide a comprehensive description of the YAML data-representation language, but is instead intended to show some of the main features and constructs of YAML that are used in SLS documents, discussed below.

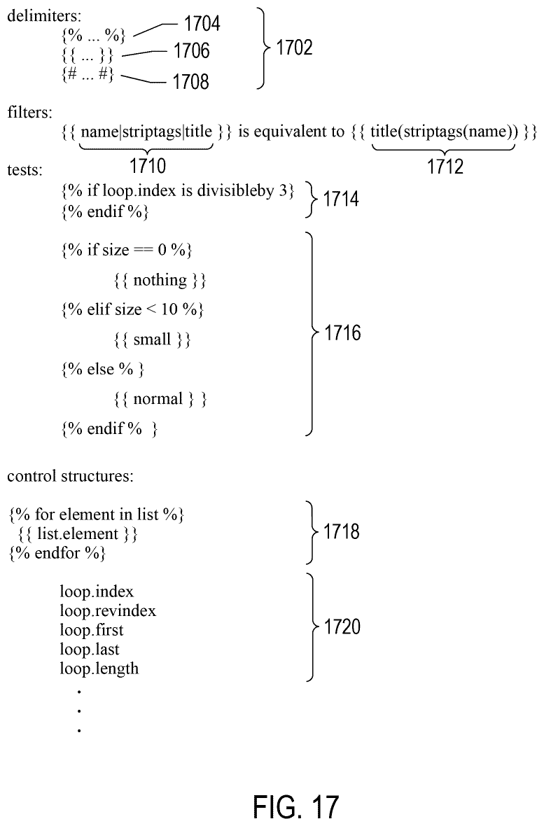

FIG. 17 illustrates certain features provided by the Jinja template engine that are used, in addition to YAML, for representing infrastructure in SLS documents. Jinja employs several types of delimiters to encode Jinja constructs. These are shown on lines 1702 of FIG. 17, with ellipses indicating that additional text is enclosed by the delimiters. A first type of delimiter 1704 is used to encapsulate tests, control structures, and other programming-language-like constructs. A second type of delimiter 1706 is used to encapsulate variables for output. A third type of delimiter 1708 is used to enclose comments. Pipe symbols “|” can be used to indicate sequences of function calls. For example, the delimited string “name|striptags|title” 1710 is equivalent to the character string 1712, which represents calling a function “title” with an argument that represents a value returned by calling the function “striptags” with the argument “name.” Jinja supports if statements, as shown by the example on lines 1714, and if-elseif-else statements, as shown by the example on lines 1716. Jinja provides a set of comparison operators used in if and if-elseif-else statements. Finally, Jinja provides various types of control structures, such as for-loops, as indicated on lines 1718. The for-loop control structure is accompanied with a number of Jinja loop variables 1720 that can be used in conditional expressions within loops. FIG. 17 does not provide a comprehensive list of examples of Jinja features and constructs, but is instead intended simply to show some of the main types of Jinja constructs that, in combination with YAML constructs and features, are used in SLS documents, described below.

The currently disclosed cloud-infrastructure-management service is referred to as the “Idem service” in the remainder of this document, for reasons discussed in a following section. The Idem service, as discussed above, receives SLS data files that describe deployment and configuration of cloud-based infrastructure. SLS data files can be represented in various different data-serialization languages, including JSON, but a combination of YAML-like and Jinja-like formatting conventions, features, and constructs are most frequently used. An Idem state file is an SLS data file that represents configuration of a cloud-based infrastructure, and Idem SLS data files serve as blueprints or cloud templates input to the Submitted Task and Validate SLS APIs of the Idem-service management interface. There are, however, many different types of Idem implementations. Idem may be considered to be a data flow programming language, for example, and an Idem system may be implemented as a collection of plug-ins that together comprise a cloud-infrastructure-management engine and a command-line interface (“CLI”). In the current document, the Idem service introduced, above with reference to FIGS. 9-11, is used as an example cloud-infrastructure-management system in which the currently disclosed automated methods for generating parameterized cloud-infrastructure templates can be incorporated, but the currently disclosed automated methods can alternatively be incorporated in other types of cloud-infrastructure-management-system implementations.

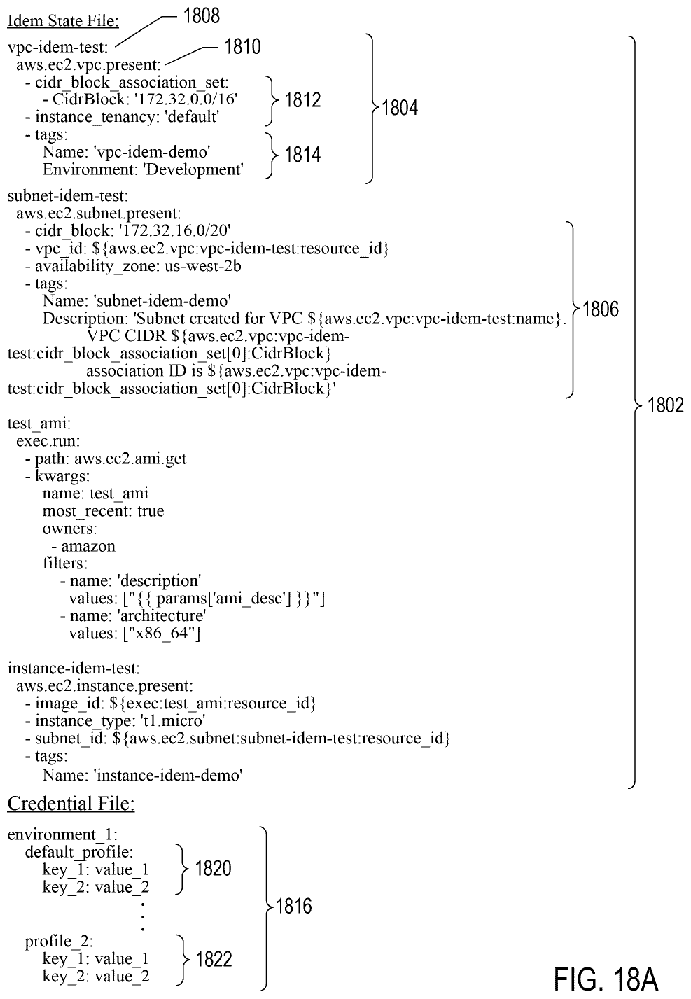

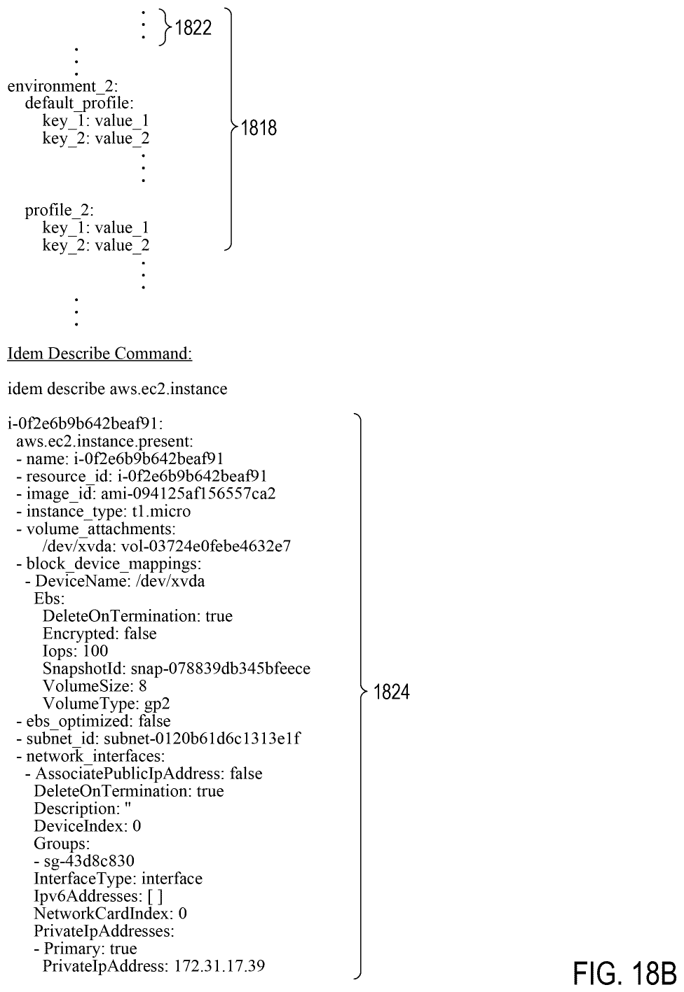

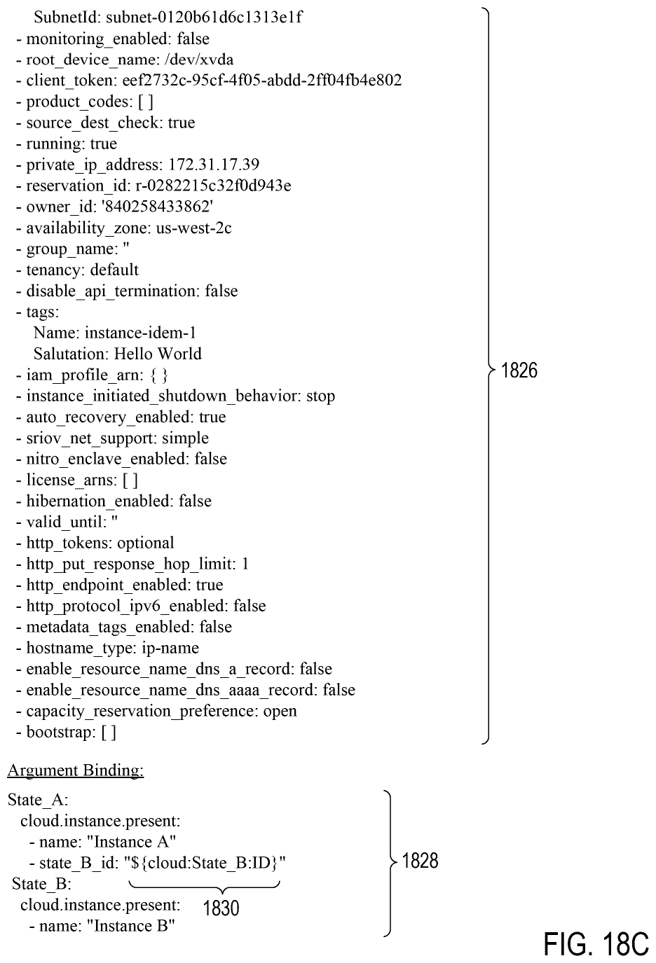

FIGS. 18A-C illustrate a structured layered state (“SLS”) data file and an SLS credential file as well as the output from an Idem describe command. A simple, example Idem state file is shown in the initial portion 1802 of FIG. 18A. The example SLS state file creates a virtual private cloud (“VPC”) for a virtual machine within an AWS cloud-computing facility and connects the VPC to an AWS subnet. A first portion of the example SLS state file 1804 specifies the VPC and a second portion of the example SLS state file 1806 specifies the subnet. Each resource includes a name, such as “vpc-item-test” 1808 for the VPC, and a directive, or function, such as “aws.cc2.vpc.present” 1810. Functions include: (1) present, which indicates that, when the resource is not currently present in the infrastructure, the resource should be allocated, deployed, and configured according to the resource descriptor and that, when the resource is currently present in the infrastructure, the Idem service resource should ensure that the current deployment and configuration of the resource corresponds to the resource descriptor; (2) absent, which indicates that, when the resource is currently allocated and deployed, the resource should be removed; and (3) describe, which requests that the Idem service return information about the resource. Resources are specified using a plug-in/resource-group/resource-type tuple, such as “aws.cc2.vpc” in directive 1810. The plug-in portion of the plug-in/resource-group/resource-type tuple refers to a particular cloud-computing facility or cloud provider which provides the executables for accessing the particular cloud-computing facility and/or a set of cloud-computing facilities managed by the cloud provider. A resource descriptor includes a list of attribute/value pairs, generally including property/value pairs 1812 tag/value pairs 1814. The attribute/value pairs are used to generate a call to a resource-type-associated function, such as the present function or a subnet resource. Of course, real-world Idem state files may contain descriptions of hundreds or thousands of resources and, in addition, a blueprint or cloud templates may include multiple hierarchically organized SLS state files. The resource-group portion of the plug-in/resource-group/resource-type tuple refers to a group or class containing multiple types of resources and the resource-type portion of the plug-in/resource-group/resource-type tuple refers to a particular type of resource, such as a virtual machine or a subnet, which is a partition of the host-address space of a virtual-private-network-address space.

The form of an SLS credential file is shown in a lower portion 1816 of FIG. 18A and an upper portion 1818 of FIG. 18B. The SLS credential file contains a block of authentication/authorization information for one or more environments, each of which corresponds to plug-ins for different types of cloud-computing-facility management interfaces. The first portion 1816 of the example SLS credential file shown in FIG. 18A contains a block of authentication/authorization information for a first environment. Each block contains authentication/authorization information for one or more profiles, such as profiles 1820 and 1822 in the block for the first environment, including a default profile 1820. The authentication/authorization information is encoded as a set of attribute/value pairs, such as the name of a particular type of authentication/authorization information, such as an access key, and the alphanumerically encoded access key. SLS credential files are used to input authentication/authorization information to the Idem-service management interface so that the authentication/authorization information can be maintained by the Idem-service management interface and used by the Idem service to access functionality provided by the management interfaces of cloud-computing facilities via the various plug-ins.

The lower portion 1824 of FIG. 18B and the upper portion 1826 of FIG. 18C show the output of an Idem-service describe command executed with respect to the infrastructure described in the Idem state file 1802 shown in FIG. 18A. The output of the Idem-service describe command has a YAML-like format and can be used to generate a corresponding Idem state file that can be subsequently used to modify and enforce the configuration of the represented infrastructure, as discussed below. A final portion 1828 of FIG. 18C illustrates argument binding in SLS data files. The character string “${cloud: State_B: ID}” represents a reference to an attribute value of an attribute in an SLS data file generated by prior execution of a portion of an SLS data file. In the example shown in the final portion of FIG. 18C, the string “${cloud: State_B: ID}” references the name of the resource State_B once that name is obtained via an Idem-service state command. Moreover, execution of the Idem-service state command orders execution of operations related to specified resources to ensure that argument bindings refer to valid attribute values.

### The Idem Service

As discussed above, the current application discloses a cloud-infrastructure-management service referred to as the “Idem service.” This name is derived from the term “idempotent.” An idempotent operation is an operation that can be first applied to an object or entity and, when the object or entity is not subsequently altered by other operations, can be again applied to the object or entity without changing the object or entity. One example of an idempotent operation is the computational operation x=x mod 5, where the initial value of x is 16. The first application of the operation x=x mod 5 sets the value of x to 1. Provided that the value of x is not altered by some other operation, a second application of the operation x=x mod 5 results in the value of x remaining 1, and this is true for any number of repeated applications of the operation x=x mod 5 provided that the value of x is not altered by application of some other operation.

FIG. 19 illustrates a fundamental control loop involving the Idem service. This control loop involves the Idem-service state command, mentioned above, which applies an SLS-data blueprint or cloud template to a cloud-computing facility. In the case that no infrastructure has yet been deployed and configured within the cloud-computing facility on behalf of the individual or organization submitting the Idem-service state command to the management interface of the Idem service, the Idem service creates, deploys, and configures infrastructure on the cloud-computing facility according to the SLS-data blueprint or cloud template. When the resulting infrastructure is not subsequently altered by other commands or events, then, when the individual or organization again submits the same SLS-data blueprint or cloud template in a subsequent Idem-service state command to the management interface of the Idem service, the infrastructure is not changed by the subsequent Idem-service state command. However, in the case that the infrastructure has been altered by various events following the initial creation, deployment, and configuration of the infrastructure, submission of the same SLS-data blueprint or cloud template in a subsequent Idem-service state command to the management interface of the Idem service returns the infrastructure to the state that the infrastructure had upon initial creation, deployment, and configuration. Thus, the Idem-service state command associated with a particular SLS-data blueprint or cloud template is idempotent, and resubmission of an Idem-service state command associated with a particular SLS-data blueprint or cloud template can be used to control unintended departures of the state of cloud-based infrastructure, referred to as “enforcement,” without the risk of causing unintended changes to the state of the infrastructure defined by the SLS-data blueprint or cloud template.

The idempotency of the Idem-service state command is reflected in the fundamental control loop 1902 illustrated in FIG. 19. There are two possible starting points 1904 and 1906 for the control loop 1902. Assuming that the loop begins at the starting point 1904, the loop begins with an SLS-data blueprint or cloud template 1908 that describes desired infrastructure to be created, deployed, and configured within a cloud-computing facility. The SLS-data blueprint or cloud template is referenced by an Idem-service state command 1910 which is submitted to the Idem service for execution 1912. Execution of the Idem-service state command 1910 produces deployed and configured infrastructure 1914 with a state corresponding to a desired state represented by the SLS-data blueprint or cloud template. Subsequent submission of an Idem-service describe command 1916 result in execution of the describe command by the Idem service 1918 which, in turn, produces Idem-service-describe-command output 1920 that represents the current state of the infrastructure. At this point, if the output from the Idem describe command does not reflect the desired state of the infrastructure, the original SLS data can be referenced by a resubmitted Idem-service state command to enforce the originally desired infrastructure state. This enforcement operation is used to correct infrastructure drift, where “infrastructure drift” means an unintended departure of the state of the infrastructure from the desired state due to intervening events or operations. By contrast, if the loop started at starting point 1906, then the output from the Idem-service describe command can be translated into SLS data that can be subsequently used to enforce the infrastructure state represented by the SLS data. Yet another possibility is that the infrastructure state represented by the describe-command output may be used to generate corresponding SLS data which can then be modified in order to generate a new infrastructure state. Thus, the fundamental control loop may continue to iterate in order to maintain the state of the infrastructure in a desired state, with modifications to the SLS-data blueprint or cloud template made to alter the infrastructure state in response to changing goals or conditions.

FIG. 20 illustrates one implementation of the Idem service. The Idem service 2002 includes an Idem-service frontend 2004, a task manager 2006, multiple Idem-service workers 2008, with the number of Idem-service workers scalable to handle dynamic workloads, an event stream 2010, and an event-processing component 2012. The Idem-service frontend 2004 includes the previously discussed set of GraphQL APIs 2014 and a database 2016 for storing information related to managed infrastructure and received Idem requests and commands. The frontend additionally includes Idem-service logic 2018 that implements command/request execution, throttling and prioritization, scheduling, enforced-state management, event ingestion, and internal communications between the various components of the Idem service. Throttling involves managing the workload accepted by the Idem service to ensure that sufficient computational resources are available to execute received commands and requests. Prioritization involves prioritizing execution of received Idem commands and requests. Scheduling involves preemption of long-running Idem-command-and-request executions. Enforced state management involves maintaining a representation of the last enforced state of a particular infrastructure managed by the Idem service in order to facilitate subsequent command/request execution. Event ingestion involves receiving, storing, and acting on events input to the Idem-service frontend by the event-processing component 2012. The various components of the Idem service communicate by message passing, as indicated by double-headed arrows 2020-2022. The task manager 2006 coordinates various stages of execution of Idem commands and requests using numerous task queues 2024-2026. Each Idem-service worker, such as Idem-service worker 2028, presents an Idem-service worker API 2030 and includes logic 2032 that implements Idem-command-and-request execution. Each Idem-service worker includes a set of one or more plug-ins, such as plug-in 2034, allowing the Idem-service worker to access the management interfaces of cloud-computing facilities on which infrastructure managed by the Idem service is deployed and configured. As they execute commands and requests, Idem-service workers publish events to the event stream 2010. These events are monitored and processed by the event-processing component 2012, which filters the events and forwards processed events to the Idem-service frontend.

### Currently Disclosed Methods and Systems

FIGS. 21A-B illustrate autocompletion and validation of a cloud-infrastructure-specification-and-configuration data file during creation of the cloud-infrastructure-specification-and-configuration data file by a user using an IDE. In this example, the user is beginning to write the Idem state file shown in FIG. 18A. The user has typed in the name for the first resource to be specified, “dhcp-config-1” 2102, followed by a colon 2104 in the visual representation of the cloud-infrastructure-specification-and-configuration data file 2106 displayed to the user by the IDE. The user has moved the input cursor 2108 to the next line in preparation for typing in the resource-type-associated function “aws.ec2.vpc.present,” where the cloud provider is “aws,” the service is “ec2,” and the resource type is “vpc.” The IDE has accessed a schema for cloud-infrastructure-specification-and-configuration data files and processed the schema to generate in-memory schema information that allows the IDE to anticipate the next input from the user. The in-memory schema information indicates to the IDE that the next item in the cloud-infrastructure-specification-and-configuration data file will be a resource-type-associated function and that the function begins with a label for a cloud provider. The IDE then consults the in-memory schema information to determine all possible cloud providers currently associated with interface plug-ins incorporated into the Idem-service, discussed above with reference to FIG. 20, and presents the user with a text-selection window 2110 including the possible cloud-provider labels. Rather than type in the cloud-provider label, the user can simply input a mouse click to the desired cloud-provider label which is then inserted into the cloud-infrastructure-specification-and-configuration data file 2112 with a following “.” delimiter symbol. At this point, the IDE consults the in-memory schema information to determine that the user will likely next type in a service label. The IDE determines the various different service labels associated with the cloud provider 2112, which the IDE presents in a second text-selection window 2114. When the user selects the desired service label, the IDE inserts the selected service label 2116 followed by a “.” delimiter symbol and presents a third text-selection window 2118 to allow the user to select a desired resource type which the IDE knows, from the in-memory schema information, should follow the service label. When the desired resource type is selected by the user, the selected resource type is inserted 2120 into the cloud-infrastructure-specification-and-configuration data file with a following “.” delimiter symbol and the IDE then displays a fourth text-selection window 2122 to allow the user to select a particular function name to complete the second text line, functions including present, absent, and describe. Note that the present function for a resource type is called to specify and configure a resource of the resource type. Autocompletion is particularly useful for adding properties and tags to resource descriptors, because properties and tags, and their associated data types, are difficult for a human user to remember.

Autocompletion provided by the IDE is not simply a convenience for users to minimize the number of keystrokes needed to input lines of text into a cloud-infrastructure-specification-and-configuration data file. Instead, autocompletion is a valuable, time-saving feature that allows a user to quickly construct cloud-infrastructure-specification-and-configuration data files without the need for searching through lengthy manuals and other printed or on-line documents in order to determine the various labels, symbolic representations of specification-and-configuration parameters, and syntax needed for cloud-infrastructure-specification-and-configuration-data-file construction. The difficulties of manual cloud-infrastructure-specification-and-configuration-data-file construction are greatly magnified by the fact that many of the constraints and requirements for cloud-infrastructure-specification-and-configuration-data-file construction depend on the current state of the IaC cloud-infrastructure-management service, including the current set of cloud-provider-interface plug-ins incorporated in a particular Idem-service instance and the current versions and feature sets of those cloud-provider-interface plug-ins. That information cannot be found in manuals and other static information sources. The currently disclosed methods and systems provide for automatic generation of cloud-infrastructure-specification-and-configuration-data-file schemas by the Idem service, or other IaC cloud-infrastructure-management systems and services, so that autocompletion is up-to-date and specific for the current state of the Idem service or other cloud-infrastructure-management system or service. Autocompletion, like validation, discussed below, is an essential component for facilitating automated cloud-infrastructure management by IaC cloud-infrastructure management systems and services, such as the Idem service.

FIG. 21B illustrates validation. Continuing with the example of FIG. 21A, the user has input the first resource descriptor and configuration, 2130 and has begun to input a second resource descriptor 2132. At this point, the IDE consults the in-memory schema information to discover that the first resource descriptor is lacking a mandatory property. The IDE highlights the input properties 2134, other than the tags property, and displays a text window 2136 indicating that the first resource descriptor is missing the cidr_block_association property. The text window also indicates the semantic meaning of the property as well as the data type of the property value. In the current example, once the user has input a mouse click to the text window, the IDE again consults the in-memory schema information to automatically insert text for the missing property 2138 along with a text-entry window 2140 to allow the user to input a value string for the property. Real-time validation of resource descriptors, properties, tags, and other features of a cloud-infrastructure-specification-and-configuration data file during construction of the cloud-infrastructure-specification-and-configuration-data file is also, like autocompletion, more than just a convenience for users. Without real-time validation, a user generally needs to complete construction of a cloud-infrastructure-specification-and-configuration-data file and then issue a command to the Idem service to compile and then apply or store the compiled cloud-infrastructure-specification-and-configuration-data file. Real-world cloud-infrastructure-specification-and-configuration-data files may be voluminous, including hundreds of thousands of states, and waiting for feedback with regard to syntax problems, missing properties, and other problems in a cloud-infrastructure-specification-and-configuration-data file following completion of the cloud-infrastructure-specification-and-configuration-data file can lead to significant temporal overheads in cloud-infrastructure-specification-and-configuration-data-file construction and significant user frustration, to the point that users may be unwilling or unable to obtain the benefits of automated cloud-infrastructure management due to unacceptable cloud-infrastructure-specification-and-configuration-data-file construction overheads.

Autocompletion and validation depend on access, by IDEs, to schema information for cloud-infrastructure-specification-and-configuration-data files, and effective autocompletion and validation depend on the schema information being up-to-date and accurate with respect to the current state of a cloud-infrastructure management service, as mentioned above. Thus, effective autocompletion and validation depend on automatic generation of cloud-infrastructure-specification-and-configuration-data-file schema by automated cloud-infrastructure management services.

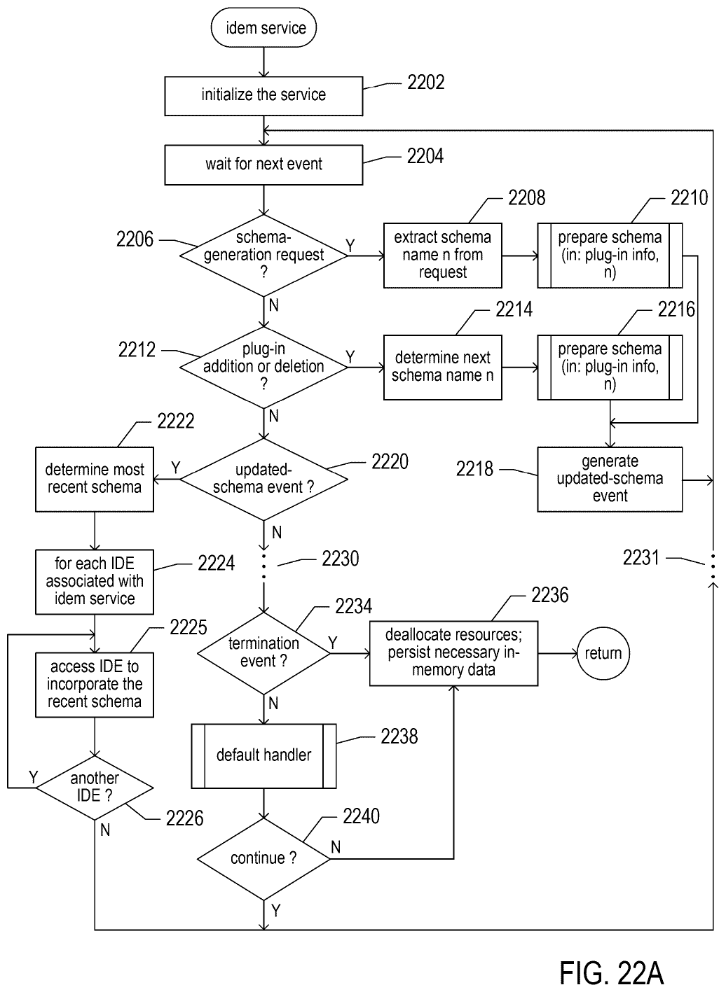

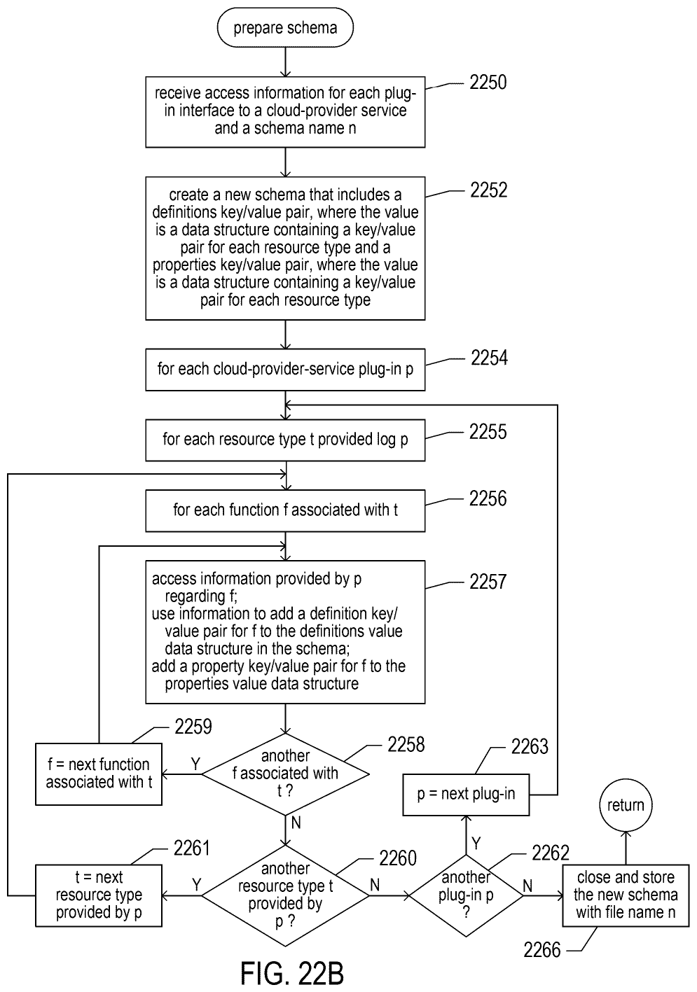

FIGS. 22A-B provide control-flow diagrams that illustrate an example implementation of automated cloud-infrastructure-specification-and-configuration-data-file schema generation. For the remainder of the current discussion, the phrase “automated schema generation” is used with the meaning “automated cloud-infrastructure-specification-and-configuration-data-file schema generation” and the term “schema” is used to mean “cloud-infrastructure-specification-and-configuration-data-file schema.” FIG. 22A shows a control-flow diagram for a routine “idem service” that represents operation of the Idem cloud-infrastructure management service discussed above with reference to FIG. 20. In step 2202, the routine “idem service” is initialized. Initialization may involve launching various executables, initializing in-memory data structures, establishing communications links, and other such tasks. Then, in step 2204, the routine “idem service” waits for the occurrence of a next event. When the next event is a schema-generation request, as determined in step 2206, a schema name n is extracted from the request, in step 2208, and a routine “prepare schema” is called in step 2210 to generate the schema. Similarly, when the next occurring event is a plug-in addition or deletion event, as determined in step 2212, a name n for a new schema is determined, in step 2214, after which the routine “prepare schema” is called in step 2216. Following either the call to the routine “prepare schema,” in step 2210, or the call to the routine “prepare schema,” in step 2216, an updated-schema event is generated, in step 2218, after which control returns to step 2204 where the routine “idem service” waits for the occurrence of a next event. When the next occurring event is an updated-schema event, as determined in step 2220, the routine “idem service” determines the most recently generated schema, in step 2222, and then, in the for-loop of steps 2224-2226, accesses each IDE associated with the Idem service and incorporates the most recent schema into the IDE. Ellipses 2230-2231 indicate that many additional types of events may be handled in the event loop that represents an implementation of the Item service shown in FIG. 22A. When the next occurring event is a termination event, as determined in step 2234, the Idem service, in step 2236, deallocates any allocated computational resources and persists any necessary in-memory data before returning. A default handler, called in step 2238, handles any rare or unexpected events. When the default handler indicates that operation should continue, as determined in step 2240, control returns to step 2204, where the Idem service waits for the occurrence of a next event. Otherwise, control flows to step 2236. In many implementations, schemas may be generated in response to user requests, timer expirations that control automatic, periodic schema generations, and other types of events. Users may manually input schemas to IDEs, through settings interfaces, in addition to automated input by the Idem-service controller through IDE interfaces.

FIG. 22B provides a control-flow diagram for the routine “prepare schema,” called in steps 2210 and 2216 of FIG. 22A. In step 2250, the routine “prepare schema” receives access information for each plug-in service interface to a cloud-provider service as well as a schema name n. In step 2252, the routine “prepare schema” creates a new schema file that includes a definitions key/value pair, where the value is a data structure containing a key/value pair for each resource-type-associated function provided by cloud-service plug-ins, and a properties key/value pair with a data-structure value containing a key/value pair for each resource-type-associated function. In the nested for-loops of steps 2254-2263, information about each function for each resource type provided by each cloud-provider-service plug-in interface is considered. The outer for-loop of steps 2254-2263 considers each cloud-provider-service plug-in p. The inner for-loop of steps 2255-2261 considers each resource type t provided through the plug-in interface by currently considered plug-in p. The innermost for-loop of steps 2256-2259 considers each function f associated with the currently considered resource t. In step 2257, the routine “prepare schema” accesses information provided through the currently considered plug-in interface p for currently considered function f. The information is then used to add a definition key/value pair for f to the definitions data-structure value in the schema under construction. In addition, a properties key/value pair for function f is added to the properties data-structure value. These data structures and key/value pairs are discussed, in detail, below. Following completion of the nested for-loops of steps 2254-2263, the new schema is closed and stored with file name n, following which the routine “prepare schema” returns. In many implementations, the information with regard to resource types and to functions associated with resource types may be collected as an initial step within the outer for-loop of steps 2254-2263, with information about any particular function later accessed from the collected information in step 2257. Many other specific implementations are possible. A significant point is that the Idem service accesses the information needed to construct a schema from the cloud-service plug-ins incorporated into the Idem service and then uses the information to construct the schema. In this way, the constructed schema reflects the current state of the Idem service, including the current cloud-provider plug-ins incorporated within the Idem service. As discussed above, an up-to-date and accurate schema is necessary for use by IDEs to provide autocompletion and validation features.

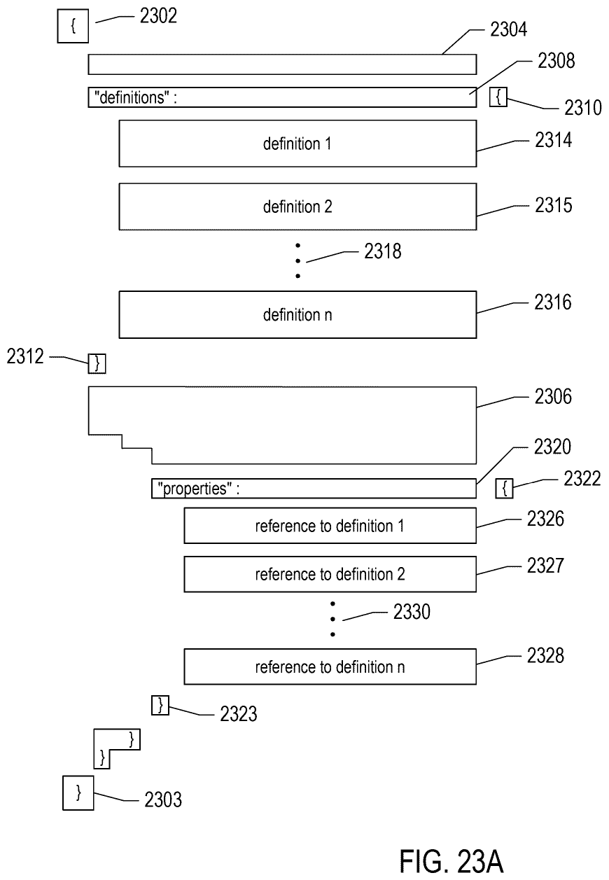

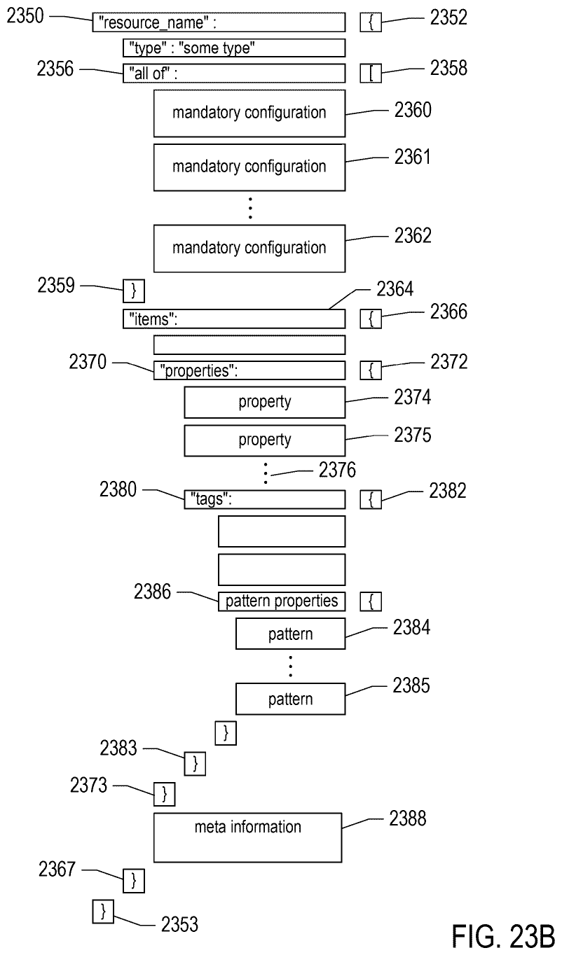

FIGS. 23A-B illustrate a schema automatically generated by the currently disclosed methods and systems. Again, by “schema,” the current discussion refers to a cloud-infrastructure-specification-and-configuration-data-file schema that is automatically generated by a cloud-infrastructure management service, including the currently described Idem service. The schema is encoded using the JSON data-description language. The schema consists of a data structure introduced by left curly bracket 2302 and terminated by right curly bracket 2303 in FIG. 23A. In FIG. 23A, labeled rectangle 2304 and rectangle-like shape 2306 represent various text lines within the schema, examples of which are discussed below. The most relevant portions of the schema, for the current discussion, include a definitions key/value pair with key “definitions” 2308 and a data-structure value that begins with left curly bracket 2310 and ends with right curly bracket 2312. The data-structure value for the definitions key/value pair includes a definition for each different resource-type-associated function provided by the cloud-provider plug-ins associated with a particular Idem service 2314-2316, with ellipsis 2318 indicating an arbitrary number of resource-type-associated-function definitions. As discussed below, each resource-type-associated-function definition is itself a key/value pair. The schema also includes a properties key/value pair with key “properties” 2320 and a data-structure value that begins with left curly bracket 2322 and ends with right curly bracket 2323. The properties data-structure value includes references 2326-2328 to the definitions contained in the definitions data-structure value, with ellipsis 2330 indicating an arbitrary number of resource-type-associated-function-definition references equal to the arbitrary number of resource-type-associated-function definitions in the definitions data-structure value. In constructing the schema, as discussed above with reference to FIG. 22B, the information for each function for each resource type provided by each cloud provider is used to create each resource-type-associated-function definition in the definitions data-structure value.

FIG. 23B illustrates a resource-type-associated-function definition within a schema automatically generated by the currently disclosed methods and systems. The resource-type-associated-function definition is a key/value pair with key 2350 comprising a name for the resource-type-associated function and a data-structure value that begins with left curly bracket 2352 and ends with right curly bracket 2353. An allOf key/value pair with key “allOf” 2356 and a list value that begins with left bracket 2358 and ends with right bracket 2359 specifies the mandatory properties included in a resource descriptor of a resource of the resource-type defined by the resource-type-associated-function definition. Each mandatory property is represented by a data-structure element 2360-2362 of the list value of the allOf key/value pair. An items key/value pair, with key “items” 2364 and a data-structure value that begins with left curly bracket 2366 and ends with right curly bracket 2367, specifies the various properties that may be included in a resource descriptor within a cloud-infrastructure-specification-and-configuration data file for a resource of the resource type represented by the resource-type-associated-function definition. The data-structure value for the items key/value pair includes a properties key/value pair with key 2370 and a data-structure value that begins with left curly bracket 2372 and ends with right curly bracket 2373. The properties data-structure value includes property descriptors 2374 and 2375, with ellipsis 2376 indicating an arbitrary number of property descriptors as well as a tags key/value pair with key “tags” 2380 and a data-structure value that begins with left curly bracket 2382 and ends with right curly data bracket 2383. The tags data-structure value includes one or more patterns 2384 and 2385, describing the syntax for tags, within the data-structure value for a patternProperties key/value pair that includes the key “patternProperties” 2386. The properties data-structure value also includes certain meta information 2388 discussed below. Thus, a resource-type-associated-function definition includes detailed information about each resource-type-associated function provided by each cloud-provider service associated with a cloud-provider plug-in incorporated within the Idem service. This detailed information includes information about mandatory properties as well as general information about the various properties that may be included in a resource descriptor within a cloud-infrastructure-specification-and-configuration data file, such as an SLS data file. It is the information contained in a schema that is used by an IDE associated with a cloud-infrastructure-management service that allows the IDE to provide the above-discussed autocompletion and validation features.

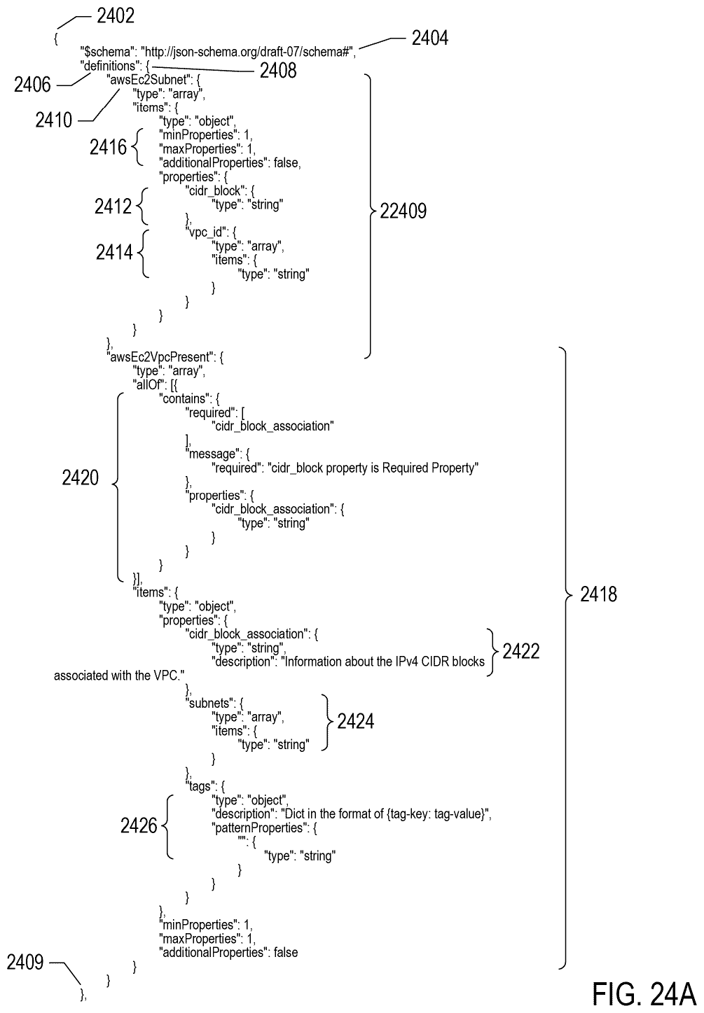

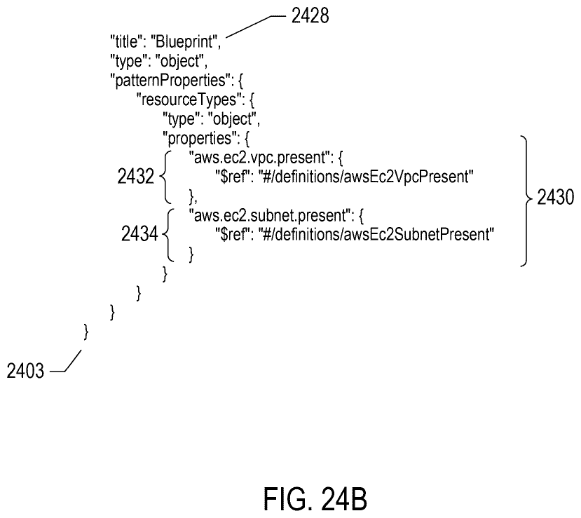

FIGS. 24A-B show a small, example schema. The schema, as discussed above with reference to FIG. 23A, is a JSON data file that includes a data-structure object the begins with bracket 2402 in FIG. 24A and ends with bracket 2403 in FIG. 24B. A second line includes an argument binding to a URL for the schema 2404. The next line includes the definitions key 2406 of the definitions key/value pair, with the data-structure value of the definitions key/value pair beginning with curly bracket 2408 and ending with curly bracket 2409. The definitions data-structure value includes a key/value pair comprising a definition for the present function for resource type aws.rc3.subnet 2409 that includes, as the key, the label “awsEc2Subnet” 2410. A resource descriptor for a resource of type aws.rc3.subnet may include a cidr_block property with a string value 2412 and a vpc_id property with an array value that includes elements of type string 2414. Metadata values for the resource type aws.rc3.subnet are represented by key/value pairs 2416. The metadata values minProperties and maxProperties are both 1 in the schema since a state is a list of resource descriptors and each resource descriptor is a single entry. In the metadata value additionalProperties is FALSE, indicating that only the properties listed in the resource-type-associated-function definition should occur in a resource descriptor for a resource of type aws.rc3.subnet. A second key/value pair comprising a definition for the present function for the resource type aws.ec2.vpc 2418 completes the data-structure value of the definitions key/value pair. A resource descriptor for the resource type aws.ec2.vpc is required to include a cidr_block_association property by the data-structure list element 2420 within the list value of the allOf key/value pair. A resource descriptor for the resource type aws.ec2.vpc may include the cidr_block_association property and a subnets property as indicated by the property-descriptor key/value pairs 2422 and 2424. A resource descriptor for the resource type aws.ec2.vpc may include tags represented by key/value pairs with string values 2426. Turning to FIG. 24B, a title for the schema is indicated by the key/value pair with key “title” 2428. The properties key/value pair 2430 includes references to the corresponding definitions for each of the present functions for resource types aws.ec2.vpc 2432 and aws.ec2.subnet 2434.

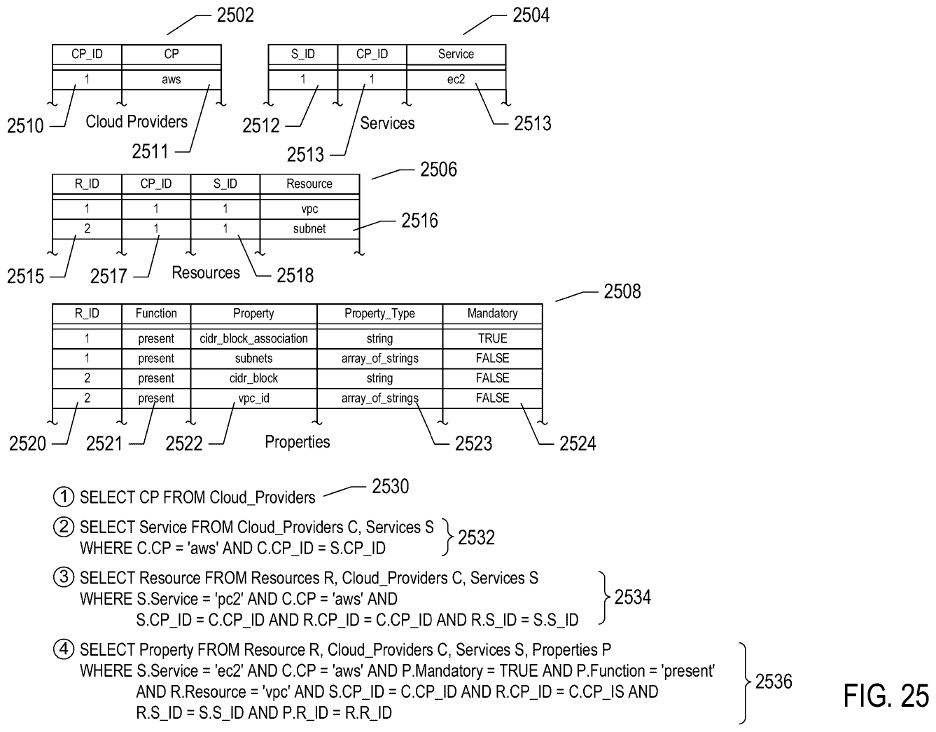

FIG. 25 illustrates use of a schema by an IDE. As mentioned above, an IDE may process a schema and generate in-memory schema information used by the IDE for autocorrelation and validation during cloud-infrastructure-specification-and-configuration data-file construction. Continuing with the example of FIGS. 21A-B based on the schema shown in FIGS. 24A-B, the in-memory schema information may comprise, in part, a Cloud-Providers table 2502, a Services table 2504, a Resources table 2506, and a Properties table 2508. Each entry in the Cloud Providers table includes a cloud-provider ID the 510 and the label for a cloud provider 2511. Each entry in the Services table includes a service identifier 2512, a cloud-provider identifier 2513, and the label for service 2514. Each entry in the Resources table includes a resource-type identifier 2515 and a label for a resource type 2516 along with a cloud-provider identifier 2517 and a service identifier 2518. Finally, each entry in the Properties table includes a resource-type identifier 2520, a function label 2521, a property label 2522, an indication of the properties type 2523, and a Boolean indication of whether or not the property is mandatory 2524. In order to provide the text-selection window 2110 in FIG. 21A, the IDE can obtain the labels for cloud providers using the SQL command 2530. In order to provide the text-selection window 2114 in FIG. 21A, the IDE can obtain the service labels via query 2532. In order to provide the text-selection window 2118 in FIG. 21A, the IDE can obtain labels for the resource types using query 2534. Finally, in order to detect the missing property described in the text window 2136 in FIG. 21B, the IDE can execute query 2536. Of course, an IDE may process a schema to generate in-memory schema information stored in a variety of different ways in addition to, or instead of, using a set of relational database tables.

The above-described schema is thus a data structure that contains information that controls operation of an IDE during construction of a cloud-infrastructure-specification-and-configuration data file. The information contained in the schema is needed for autocompletion and validation features that are essential for facilitating efficient use of cloud-infrastructure-specification-and-configuration data files in the cloud-infrastructure-management service controlled by such data files by human users. Otherwise, as mentioned above, a human user might need to tediously refer to manuals and other types of information while constructing a cloud-infrastructure-specification-and-configuration data file and may still failed to properly construct the cloud-infrastructure-specification-and-configuration data file as a result of not knowing the current state of the cloud-infrastructure-management service, including the cloud-provider plug-ins currently incorporated into the cloud-infrastructure-management service and therefore not knowing the available resource types.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters. While the JSON data-definition language can be used for schemas, as discussed above, additional types of data-definition languages and/or data-formatting conventions may be used in alternative implementations. While the automatically generated schemas are used by IDEs for autocompletion and validation features, the schema information may be additionally used for other types of features and services.

What claimed is:

1. An automated infrastructure-as-code cloud-infrastructure manager comprising:
one or more computer systems, each containing one or more processors, one or more memories, and one or more data-storage devices; and
processor instructions, stored in one or more of the one or more memories that, when executed by one or more of the one or more processors, control the one or more computer systems to implement the automated infrastructure-as-code cloud-infrastructure manager, the infrastructure-as-code cloud-infrastructure manager comprising:
a management interface that receives cloud-infrastructure-management commands and requests, including idempotent state commands that deploy and configure cloud infrastructure;
an execution engine that executes the received cloud-infrastructure-management commands and requests; and
a schema generator that generates a schema for cloud-infrastructure-specification-and-configuration files that specify resources that are deployed and configured.

2. The automated infrastructure-as-code cloud-infrastructure manager of claim 1 wherein the schema generator generates a schema comprising:
definitions for resource-type-associated functions; and
references to the definitions for resource-type-associated functions.

3. The automated infrastructure-as-code cloud-infrastructure manager of claim 1 wherein a resource-type-associated function is specified by:
a tuple comprising:
an identifier for a cloud-provider;
an identifier for a service provided by the cloud provider; and
an identifier for a type of resource provided by the service; and
a resource-type-associated function name.

4. The automated infrastructure-as-code cloud-infrastructure manager of claim 2 wherein the schema is encoded in JSON data-description language.

5. The automated infrastructure-as-code cloud-infrastructure manager of claim 2 wherein each definition for a resource-type-associated function includes indications of properties and tags, which may be included in a resource descriptor within a cloud-infrastructure-specification-and-configuration file, that specify argument values included in a call to the resource-type-associated function when the cloud-infrastructure-specification-and-configuration file is used by the infrastructure-as-code cloud-infrastructure manager to specify and configure cloud infrastructure.

6. The automated infrastructure-as-code cloud-infrastructure manager of claim 5 wherein a definition for a resource-type-associated function comprises:
a list of mandatory properties to be included in a resource descriptor, within a cloud-infrastructure-specification-and-configuration file, for a resource of the resource type associated with the resource-type-associated function; and
a set of property descriptors that describe properties that may be included in a resource descriptor in a cloud-infrastructure-specification-and-configuration file for a resource of the resource type associated with the resource-type-associated function, each property descriptor including a property name and an indication of the data type of the property value.

7. The automated infrastructure-as-code cloud-infrastructure manager of claim 6 wherein one of the property descriptors for properties associated with a resource-type-associated function in a definition for the resource-type-associated function in the schema, indicates possible data types for tags that may be included in a resource descriptor in a cloud-infrastructure-specification-and-configuration file for a resource of the resource type associated with the resource-type-associated function.

8. The automated infrastructure-as-code cloud-infrastructure manager of claim 5 wherein the schema generator generates a schema for cloud-infrastructure-specification-and-configuration files that specify the resources that are deployed and configured by the infrastructure-as-code cloud-infrastructure manager by:
creating a new schema file;
accessing information, from each cloud-provider plug-in incorporated in the automated infrastructure-as-code cloud-infrastructure manager, regarding the resource-type-associated functions supported by the cloud-provider; and
for each resource-type-associated function supported by a cloud-provider:
determining function arguments, parameters, and characteristics of the resource-type-associated function from the information accessed from the cloud-provider;
using the determined function arguments, parameters, and characteristics to generate a definition for the resource-type-associated function;
adding the generated resource-type-associated-function definition to the definitions for resource-type-associated functions in the schema encoded in the new schema file; and
adding a reference to the generated resource-type-associated-function definition to the references to the definitions for resource-type-associated functions in the schema encoded in the new schema file.

9. The automated infrastructure-as-code cloud-infrastructure manager of claim 1
wherein the automated infrastructure-as-code cloud-infrastructure manager is associated with one or more integrated development environments; and
wherein a schema generated by the schema generator of the automated infrastructure-as-code cloud-infrastructure manager is incorporated into one or more of the one or more integrated development environments.

10. The automated infrastructure-as-code cloud-infrastructure manager of claim 9 wherein an integrated development environment into which the schema is incorporated uses the schema to provide autocompletion and validation features to a user of the integrated development environment as the user constructs a cloud-infrastructure-specification-and-configuration file.

11. A method that generates schema for cloud-infrastructure-specification-and-configuration files that specify resources that are deployed and configured by an automated infrastructure-as-code cloud-infrastructure manager, the method comprising:
creating a new schema file; and
for each resource-type-associated function supported by a cloud-provider incorporated in the automated infrastructure-as-code cloud-infrastructure manager:
determining function arguments, parameters, and characteristics of the resource-type-associated function;
using the determined function arguments, parameters, and characteristics to generate a definition for the resource-type-associated function;
adding the generated resource-type-associated-function definition to the schema encoded in the new schema file; and
adding a reference to the generated resource-type-associated-function definition in the schema encoded in the new schema file.

12. The method of claim 11 wherein the automated infrastructure-as-code cloud-infrastructure manager comprises:
one or more computer systems, each containing one or more processors, one or more memories, and one or more data-storage devices; and
processor instructions, stored in one or more of the one or more memories that, when executed by one or more of the one or more processors, control the one or more computer systems to implement the automated infrastructure-as-code cloud-infrastructure manager, the infrastructure-as-code cloud-infrastructure manager comprising:
a management interface that receives cloud-infrastructure-management commands and requests, including idempotent state commands that deploy and configure cloud infrastructure;
an execution engine that executes the received cloud-infrastructure-management commands and requests; and
a schema generator that generates the schema by the method of claim 11.

13. The method of claim 11 wherein a resource-type-associated function is specified by:
a tuple comprising:
an identifier for a cloud-provider;
an identifier for a service provided by the cloud provider; and
an identifier for a type of resource provided by the service; and
a resource-type-associated function name.

14. The method of claim 11 wherein the schema is encoded in JSON data-description language.

15. The method of claim 11 wherein the schema comprises:
definitions for resource-type-associated functions; and
references to the definitions for resource-type-associated functions.

16. The method of claim 15 wherein each definition for a resource-type-associated function includes indications of properties and tags, which may be included in a resource descriptor within a cloud-infrastructure-specification-and-configuration file, that specify argument values included in a call to the resource-type-associated function when the cloud-infrastructure-specification-and-configuration file is used by the infrastructure-as-code cloud-infrastructure manager to specify and configure cloud infrastructure.

17. The method of claim 16 wherein a definition for a resource-type-associated function comprises:
a list of mandatory properties to be included in a resource descriptor, within a cloud-infrastructure-specification-and-configuration file, for a resource of the resource type associated with the resource-type-associated function; and
a set of property descriptors that describe properties that may be included in a resource descriptor in a cloud-infrastructure-specification-and-configuration file for a resource of the resource type associated with the resource-type-associated function, each property descriptor including a property name and an indication of the data type of the property value.

18. The method of claim 17 wherein one of the property descriptors for properties associated with a resource-type-associated function in a definition for the resource-type-associated function in the schema, indicates possible data types for tags that may be included in a resource descriptor in a cloud-infrastructure-specification-and-configuration file for a resource of the resource type associated with the resource-type-associated function.

19. The method of claim 11:
wherein the automated infrastructure-as-code cloud-infrastructure manager is associated with one or more integrated development environments;
wherein a schema generated by the schema generator of the automated infrastructure-as-code cloud-infrastructure manager is incorporated into one or more of the one or more integrated development environments; and
wherein an integrated development environment into which the schema is incorporated uses the schema to provide autocompletion and validation features to a user of the integrated development environment as the user constructs a cloud-infrastructure-specification-and-configuration file.

20. A physical data-storage device encoded with processor instructions that, when executed by one or more processors within one or more computer systems, each containing one or more processors, one or more memories, and one or more data-storage devices, control the one or more computer systems to implement an automated infrastructure-as-code cloud-infrastructure manager, the automated infrastructure-as-code cloud-infrastructure manager comprising:
a management interface that receives cloud-infrastructure-management commands and requests, including idempotent state commands that deploy and configure cloud infrastructure;
an execution engine that executes the received cloud-infrastructure-management commands and requests; and
a schema generator that generates a schema for cloud-infrastructure-specification-and-configuration files that specify resources that are deployed and configured by:
for each resource-type-associated function supported by a cloud-provider incorporated in the automated infrastructure-as-code cloud-infrastructure manager:
determining function arguments, parameters, and characteristics of the resource-type-associated function;
using the determined function arguments, parameters, and characteristics to generate a definition for the resource-type-associated function;
adding the generated resource-type-associated-function definition to the schema encoded in a new schema file; and
adding a reference to the generated resource-type-associated-function definition in the schema encoded in the new schema file.
